(19) United States
(12) Patent Application Publication
(10) Pub. No.: US 2026/0342976 A1
(43) Pub. Date: Oct. 29, 2026

(54) FILTERING METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Renjie CHANG, Shenzhen (CN); Liqiang Wang, Shenzhen (CN)

(73) Assignee: TENCENT TECHNOLOGY (SHENZHEN) COMPANY LIMITED, Shenzhen (CN)

(21) Appl. No.: 19/533,470

(22) Filed: Feb. 9, 2026

Related U.S. Application Data
(63) Continuation of application No. PCT/CN2024/129759, filed on Nov. 4, 2024.

(30) Foreign Application Priority Data
Nov. 9, 2023 (CN) 202311495894.1

(51) Int. Cl. H04N 19/117; H04N 19/186; H04N 19/80

(52) U.S. Cl. CPC H04N 19/117; H04N 19/186; H04N 19/80

(57) ABSTRACT

A method, apparatus, and computer-readable storage medium for an improved filtering process during video compression is provided. The method obtains data to be filtered. A plurality of data processing modes of the data is determined based on the data being filtered using a neural network filter. The data is then filtered using the neural network filter to obtain corresponding filtered data based on the plurality of data processing modes.

### CROSS REFERENCE TO RELATED APPLICATIONS

This application is a bypass continuation application of International Patent Application No. PCT/CN2024/129759, filed on Nov. 4, 2024, which claims priority to and is based on Chinese Patent Application No. 202311495894.1, filed on Nov. 9, 2023, the disclosures of which are incorporated herein in their entireties by reference.

### FIELD

The present disclosure relates to the field of video coding and decoding technologies, and in particular, to a filtering method and apparatus, an electronic device, and a storage medium.

### BACKGROUND

To facilitate transmission of video data, a video apparatus performs a video compression technology to more efficiently transmit or store the video data. During the video compression, a coder and a decoder each need to perform operations such as inverse quantization and inverse transformation to obtain a reconstructed picture. Because loss occurs during the video compression, after the reconstructed picture is obtained, the reconstructed picture may need to be filtered to reduce the compression loss of the reconstructed picture.

Usually, the reconstructed picture may be filtered by using a deblocking filter (DBF) technology, a sample adaptive offset (SAO) technology, an adaptive loop filter (ALF) technology, or the like. However, with development of technologies, a better filtering technology still needs to be found to improve filtering performance.

### SUMMARY

Provided are a filtering method and apparatus, an electronic device, a storage medium, and a program product, which can improve filtering effect, decoding efficiency, and decoding performance.

According to an aspect of some embodiments of the present disclosure, a filtering method includes obtaining data to be filtered; based on the data being filtered using a neural network filter, determining a plurality of data processing modes of the data; and filtering, based on the plurality of data processing modes, the data using the neural network filter to obtain corresponding filtered data.

According to an aspect of some embodiments of the present disclosure, a filtering apparatus includes at least one memory configured to store program code; and at least one processor configured to read the program code and operate as instructed by the program code, the program code including: an obtaining code configured to cause the at least one of the at least one processor to obtain data; a determining code configured to cause the at least one of the at least one processor to, when the data is filtered using a neural network filter, determine a plurality of data processing modes of the data; and a filtering code configured to cause the at least one of the at least one processor to filter, based on the plurality of data processing modes, the data using the neural network filter to obtain corresponding filtered data.

According to an aspect of some embodiments of the present disclosure, a non-transitory computer-readable storage medium, storing computer code which, when executed by at least one processor, causes the at least one processor to at least obtain data to be filtered; based on the data being filtered using a neural network filter, determine a plurality of data processing modes of the data; and filter, based on the plurality of data processing modes, the data using the neural network filter to obtain corresponding filtered data.

Details of one or more embodiments of the present disclosure are set forth in the accompanying drawings and descriptions below. Other features and advantages of the present disclosure will be apparent from the specification, accompanying drawings, and claims.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic block diagram of a video coding and decoding system according to an embodiment.

FIG. 2 is a schematic block diagram of a video coder according to an embodiment.

FIG. 3 is a schematic structural diagram of a relationship between a coding tree unit (CTU) and a coding unit (CU) according to an embodiment.

FIG. 4 is a schematic block diagram of a video decoder according to an embodiment.

FIG. 5 shows another example of a video coder according to an embodiment.

FIG. 6 is a schematic structural diagram of a CTU according to an embodiment.

FIG. 7 is a schematic diagram of a filtering principle of a neural network in-loop filter (NNLF) according to an embodiment.

FIG. 8 is a schematic diagram of a filtering principle of a temporal NNLF according to an embodiment.

FIG. 9 shows an example of a rotation principle of a rotation mode in a transform policy according to an embodiment.

FIG. 10 shows an example of a flipping principle of a flipping mode in a transform policy according to an embodiment.

FIG. 11 shows an example of a fusion principle of a fusion policy according to an embodiment.

FIG. 12 is a schematic flowchart of a filtering method according to an embodiment.

FIG. 13 shows an example of a to-be-filtered picture block according to an embodiment.

FIG. 14 is another schematic flowchart of a filtering method according to an embodiment.

FIG. 15 is another schematic flowchart of a filtering method according to an embodiment.

FIG. 16 is another schematic flowchart of a filtering method according to an embodiment.

FIG. 17 is a schematic block diagram of a filtering apparatus according to an embodiment.

FIG. 18 is another schematic block diagram of a filtering apparatus according to an embodiment.

FIG. 19 is another schematic block diagram of a filtering apparatus according to an embodiment.

FIG. 20 is another schematic block diagram of a filtering apparatus according to an embodiment.

FIG. 21 is a schematic block diagram of an electronic device according to an embodiment.

### DETAILED DESCRIPTION

The technical solutions in the embodiments of the present disclosure will be clearly and completely described below with reference to the accompanying drawings in the embodiments of the present disclosure. The described embodiments are not to be construed as a limitation to the present disclosure. All other embodiments obtained by a person of ordinary skill in the art without creative efforts shall fall within the protection scope of the present disclosure.

For ease of understanding the technical solutions provided in the present disclosure, related terms are described below.

Terms used in the implementations of this application are merely intended for explaining the embodiments of the present disclosure but not to limit the present disclosure.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

The term “and/or” in the present disclosure describes only an association relationship for describing associated objects and indicates that three relationships may exist. For example, “A and/or B” may refer to the following three cases: only A exists, both A and B exist, or only B exists. The term “at least one of” describes only a combination relationship of listed objects and refers to that one or more items may exist. For example, “at least one of the following: A, B, and C” may refer to the following combination cases: only A exists, only B exists, only C exists, both A and B exist, both A and C exist, both B and C exist, or all of A, B, and C exist. The term “a plurality of” may refer to two or more. The character “/” may refer to an “or” relationship between associated objects.

The term “corresponding to” may refer to (i) a direct correspondence or an indirect correspondence between two objects, (ii) an association relationship between two objects, (iii) a relationship of indicating and being indicated, or (iv) a relationship of configuring and being configured.

The term “indicate” may refer to a direct indication, an indirect indication, or an association relationship. For example, “A indicates B” may mean: (i) A directly indicates B, or B may be obtained using A; (ii) A indirectly indicates B, for example, when A indicates C, and B may be obtained using C; or (iii) A and B have an association relationship.

The term “predefine” or “preconfigure” may indicate that corresponding code, tables, or other related information that can be used to indicate that the corresponding code, the tables, or the other related information may be (i) pre-stored on a device, or (ii) agreed upon in a protocol. The “protocol” may be a standard protocol in the art.

The term “when” may be interpreted as “in a case that”, “if”, “during”, “in response to”, or similar descriptions. Similarly, depending on the context, the phrase “if determining” or “if detecting (a stated condition or event)” may be interpreted as “when determining”, “in response to determining”, “when detecting (the stated condition or event)”, “in response to detecting (the stated condition or event)”, or similar descriptions. The terms “first”, “second”, “third”, “fourth”, “A^{th}”, “B^{th}”, and the like are intended to distinguish between different objects, but not to describe a specific sequence.

The terms “include”, “have”, and any variants thereof are intended to cover a non-exclusive inclusion.

Digital video compression technology is primarily used to compress large amount of digital image and video data for transmission, storage, and similar purposes.

The solutions provided in the present disclosure relate to the field of digital compression technologies.

The solutions provided in the present disclosure may be applied to the field of digital video coding technologies.

The field of digital video coding technologies includes, but is not limited to, at least one of the following: the field of picture coding and decoding, the field of video coding and decoding, the field of hardware video coding and decoding, the field of dedicated circuit video coding and decoding, and the field of real-time video coding and decoding.

In addition, the solutions provided in the present disclosure may be combined with the following standards: an audio video coding standard (AVS), a second-generation AVS standard (AVS2), or a third-generation AVS standard (AVS3), for example, including, but not limited to, an H.264/audio video coding (AVC) standard, an H.265/high efficiency video coding (HEVC) standard, and an H.266/versatile video coding (VVC) standard.

In addition, the solutions provided in the present disclosure may be configured to perform lossy compression on a picture, or to perform lossless compression on a picture. The lossless compression may be visually lossless compression, or mathematically lossless compression.

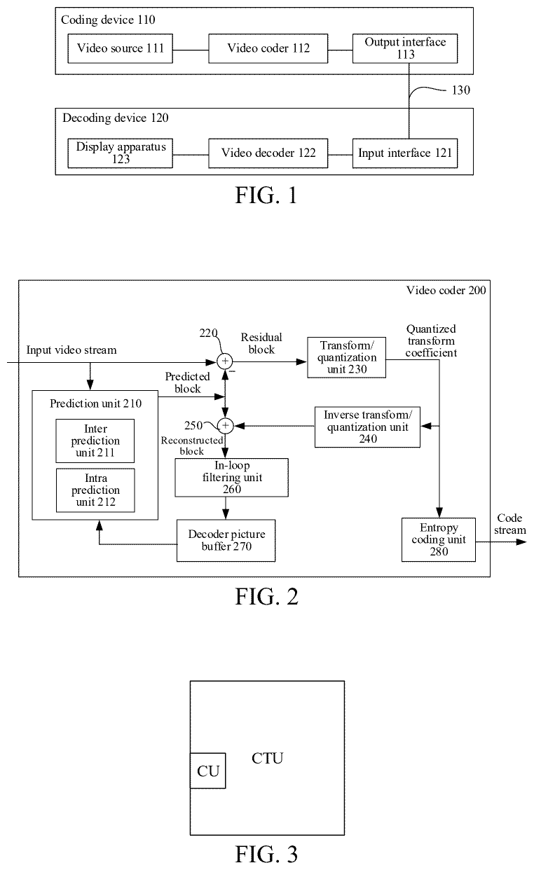

For ease of understanding, a video coding and decoding system in the embodiments of the present disclosure is first described with reference to FIG. 1.

FIG. 1 is a schematic block diagram of a video coding and decoding system according to an embodiment of the present disclosure.

As shown in FIG. 1, the video coding and decoding system 100 includes a coding device 110 and a decoding device 120.

The coding device 110 is configured to code (which may be understood as compressing) video data to generate a code stream, and transmit the code stream to the decoding device 120. The decoding device 120 decodes the code stream generated by the coding device 110 through coding in order to obtain decoded video data.

The coding device 110 may be understood as a device with a video coding function, and the decoding device 120 may be understood as a device with a video decoding function. In particular, according to the embodiment of the present disclosure, the coding device 110 and the decoding device 120 include a wider range of apparatuses, for example, a smartphone, a desktop computer, a mobile computing apparatus, a notebook computer (for example, laptop), a tablet computer, a set-top box, a television, a camera, a display apparatus, a digital media player, a video game console, and an in-vehicle computer.

The coding device 110 may transmit coded video data (for example, a code stream) to the decoding device 120 through a channel 130.

The channel 130 may include one or more media and/or apparatuses capable of transmitting the coded video data from the coding device 110 to the decoding device 120.

The channel 130 may include one or more communication media enabling the coding device 110 to directly transmit the coded video data to the decoding device 120 in real time. The coding device 110 may modulate the coded video data according to a communication standard and transmit modulated video data to the decoding device 120. The communication medium includes a wireless communication medium, for example, a radio frequency spectrum. The communication medium may further include a wired communication medium, for example, one or more physical transmission lines.

The channel 130 may include a storage medium. The storage medium may store video data coded by the coding device 110. The storage medium includes a plurality of types of local access data storage media, for example, a compact disc, a DVD, and a flash memory. In this example, the decoding device 120 may obtain the coded video data from the storage medium.

The channel 130 may include a storage server. The storage server may store the video data coded by the coding device 110. In this example, the decoding device 120 may download the stored coded video data from the storage server. In some embodiments, the storage server may store the coded video data and may transmit the coded video data to the decoding device 120, for example, a web server (for example, a website) or a file transfer protocol (FTP) server.

The coding device 110 includes a video coder 112 and an output interface 113.

The output interface 113 may include a modulator/demodulator (modem) and/or a transmitter. The video coder 112 directly transmits the coded video data to the decoding device 120 through the output interface 113. The coded video data may be further stored in the storage medium or on the storage server in order to be subsequently read by the decoding device 120.

In addition to the video coder 112 and the input interface 113, the coding device 110 may further include a video source 111.

The video source 111 may include at least one of a video capture apparatus (for example, a video camera), a video archive, a video input interface, and a computer graphics system. The video input interface is configured to receive video data from a video content provider. The computer graphics system is configured to generate video data. The video coder 112 codes video data from the video source 111 in order to generate a code stream. The video data may include one or more pictures or a sequence of pictures. The code stream includes coded information of the picture or the sequence of pictures in a form of a bitstream. The coded information may include coded picture data and associated data. The associated data may include a sequence parameter set (SPS), a picture parameter set (PPS), and another syntax structure. The SPS may include parameters applied to one or more sequences. The PPS may include parameters applied to one or more pictures. The syntax structure is a set of zero or more syntax elements arranged in a specified order in the code stream.

The decoding device 120 includes an input interface 121 and a video decoder 122. The input interface 121 may include a receiver and/or a modem.

In addition to the input interface 121 and the video decoder 122, the decoding device 120 may further include a display apparatus 123.

The input interface 121 may receive the coded video data through the channel 130. The video decoder 122 is configured to decode the coded video data to obtain decoded video data, and transmit the decoded video data to the display apparatus 123. The display apparatus 123 displays the decoded video data. The display apparatus 123 may be integrated with the decoding device 120 or may be external to the decoding device 120. The display apparatus 123 may include a plurality of types of display apparatuses, for example, a liquid crystal display (LCD), a plasma display, an organic light-emitting diode (OLED) display, or another type of display apparatus.

FIG. 1 is merely an example of the present disclosure, and is not construed as a limitation on the present disclosure. To be specific, the technical solutions in the embodiments of the present disclosure are not limited to the system framework shown FIG. 1. For example, the technology of the present disclosure may be further applied to single-side video coding or single-side video decoding.

A video coding framework in the embodiments of the present disclosure is described below.

FIG. 2 is a schematic block diagram of a video coder 200 according to an embodiment of the present disclosure.

The video coder 200 may be applied to picture data in a luminance and chrominance (YCbCr, YUV) format. For example, a YUV ratio may be 4:2:0, 4:2:2, or 4:4:4, where Y represents luminance, Cb (U) represents blue chrominance, Cr (V) represents red chrominance, and U and V represent chrominance for describing colors and saturation. For example, in a color format, 4:2:0 indicates that every four pixels have four luminance components and two chrominance components (YYYYCbCr), 4:2:2 indicates that every four pixels have four luminance components and four chrominance components (YYYYCbCrCbCr), and 4:4:4 indicates full pixel display (YYYYCbCrCbCrCbCrCbCr). The video coder 200 may alternatively be applied to picture data in a red-green-blue (RGB) format. This is not limited in the present disclosure.

After reading a video stream, the video coder 200 may divide each frame of picture in the video stream into several CTUs. In some examples, the CTU may be referred to as a tree block, a largest coding unit (LCU), or a coding tree block (CTB). A size of one CTU may be, for example, 128×128, 64×64, or 32×32.

FIG. 3 is a schematic structural diagram of a relationship between a CTU and a CU according to an embodiment of the present disclosure.

As shown in FIG. 3, one CTU may be further divided into several CUs for coding. The CU may be a rectangular block or a square block. The CU may be further divided into a prediction unit (PU) and a transform unit (TU), so that coding, prediction, and transformation are decoupled, and the processing by the CTU may be more flexible. In an example, the CTU is divided into CUs in a tree (for example, quadtree) form, and the CU is divided into the TU and the PU in a tree (for example, quadtree) form.

The video coder and the video decoder may support various PU sizes.

Assuming that a size of a specific CU is 2N×2N, the video coder and the video decoder may support a PU size of 2N×2N or N×N for intra prediction, and support a symmetric PU of 2N×2N, 2N×N, N×2N, N×N, or a similar size for inter prediction. The video coder and the video decoder may further support asymmetric PUs of 2N×nU, 2N×nD, nL×2N, and nR×2N for inter prediction.

As shown in FIG. 2, the video coder 200 may include a prediction unit 210, a residual unit 220, a transform/quantization unit 230, an inverse transform/quantization unit 240, a reconstruction unit 250, an in-loop filtering unit 260, a decoder picture buffer (DPB) 270, and an entropy coding unit 280. The video coder 200 may include more, fewer, or different functional components. In the present disclosure, a current block may be referred to as a current CU, a current PU, or the like. A predicted block may also be referred to as a predicted picture block or a picture prediction block, and a reconstructed picture block may also be referred to as a reconstructed block or a picture reconstruction block.

The prediction unit 210 includes an inter prediction unit 211 and an intra prediction unit 212. Due to a strong correlation between adjacent pixels in a picture of a video, in a video coding and decoding technology, spatial redundancy between adjacent pixels is eliminated by an intra prediction method. Due to a strong similarity between adjacent pictures in a video, temporal redundancy between adjacent pictures is eliminated by an inter prediction method in order to improve coding efficiency.

The inter prediction unit 211 may be configured to perform inter prediction, and may include motion estimation and motion compensation. Regarding the inter prediction, based on picture information of different frames, a reference block may be found from a reference frame using motion information, and a predicted block is generated based on the reference block to eliminate the temporal redundancy. The reference frame may be a P frame and/or a B frame. The P frame is a forward predicted frame, and the B frame is a bidirectional predicted frame.

Regarding the inter prediction, after the reference block is found using the motion information, the predicted block is generated based on the reference block. The motion information includes a frame list to which the reference frame belongs, a frame index, and a motion vector. The motion vector may be integer-pixel or fractional-pixel. If the motion vector is fractional-pixel, a fractional-pixel block may be made in the reference frame through interpolation filtering. The reference block is an integer-pixel or fractional-pixel block found based on the motion vector. In some technologies, the reference block is directly used as the predicted block. In some technologies, the predicted block is generated by further processing based on the reference block. Generating the predicted block by further processing based on the reference block may alternatively be understood as treating the reference block as a predicted block and then performing processing based on the predicted block to generate a new predicted block.

The intra prediction unit 212 predicts pixel information in a current coding picture block only based on information of a same frame of picture to eliminate the spatial redundancy. A reference frame used for the intra prediction may be an I frame.

The intra prediction includes a plurality of prediction modes. Prediction may be performed on a to-be-coded picture block in an angular prediction mode or a non-angular prediction mode to obtain a predicted block. An optimal prediction mode for the to-be-coded picture block is selected based on rate distortion information obtained through calculation using the predicted block and the to-be-coded picture block, and the prediction mode is written to a code stream for transmission to the decoder side. The decoder side parses out the prediction mode, obtains a predicted block of a target decoding block through prediction, and superposes the predicted block with a time-domain residual block obtained based on the code stream to obtain a reconstructed block.

H series international digital video coding standards are used as an example. An H.264/AVC standard has eight angular prediction modes and one non-angular prediction mode, and H.265/HEVC is extended to 33 angular prediction modes and two non-angular prediction modes. Intra prediction modes used in HEVC include a total of 35 prediction modes: a planar mode, a direct current (DC) mode, and 33 angular modes. Intra modes used in VVC include a total of 67 prediction modes: a planar mode, a DC mode, and 65 angular modes; and each of the intra modes may include a conventional prediction mode and a non-conventional prediction mode. The non-conventional prediction mode may include a matrix weighted intra prediction (MIP) mode. The conventional prediction mode may include a planar mode with a mode number 0, a DC mode with a mode number 1, and angular prediction modes with a mode number 2 to a mode number 66. With an increase in angular modes, a prediction result of the intra prediction is more accurate and better conforms to requirements for development of high-definition and ultra-high-definition digital videos. The foregoing intra prediction modes are merely examples of the present disclosure, and do not constitute a limitation on the present disclosure.

The residual unit 220 may generate a residual block of a CU based on a pixel block of the CU and a predicted block of a PU of the CU. For example, the residual unit 220 may generate the residual block of the CU, so that each sample in the residual block has a value equal to a difference between a sample in the pixel block of the CU and a corresponding sample in the predicted block of the PU of the CU.

The transform/quantization unit 230 may quantize a transform coefficient. The transform/quantization unit 230 may quantize, based on a quantization parameter (QP) value associated with the CU, a transform coefficient associated with a TU of the CU. The video coder 200 may adjust a quantization degree applied to the transform coefficient associated with the CU by adjusting the QP value associated with the CU.

The inverse transform/quantization unit 240 may apply inverse quantization and inverse transform to a quantized transform coefficient to reconstruct a residual block from the quantized transform coefficient.

The reconstruction unit 250 may add samples of the reconstructed residual block to a corresponding samples of one or more predicted blocks generated by the prediction unit 210 to generate a reconstructed picture block associated with the TU. In this manner, a sampling block of each TU of the CU is reconstructed, and the video coder 200 may reconstruct a pixel block of the CU.

The in-loop filtering unit 260 is configured to process pixels obtained through inverse transform and inverse quantization to compensate for distortion information and provide a better reference for subsequent coded pixels. For example, a deblocking filtering operation may be performed to alleviate blocking artifact of pixel blocks associated with the CU. In some embodiments, the in-loop filtering unit 260 includes a DBF unit and an SAO/ALF unit. The DBF unit is configured to eliminate blocking artifact, and the SAO/ALF unit is configured to eliminate ringing artifact.

The DPB 270 may store a reconstructed pixel block.

The inter prediction unit 211 may perform inter prediction on a PU of another picture by using a reference picture that is in the DPB 270 and that includes the reconstructed pixel block. In addition, the intra prediction unit 212 may perform intra prediction on another PU in the same picture as the CU by using the reconstructed pixel block in the DPB 270.

The entropy coding unit 280 may receive the quantized transform coefficient from the transform/quantization unit 230. The entropy coding unit 280 may perform one or more entropy coding operations on the quantized transform coefficient to generate entropy-coded data.

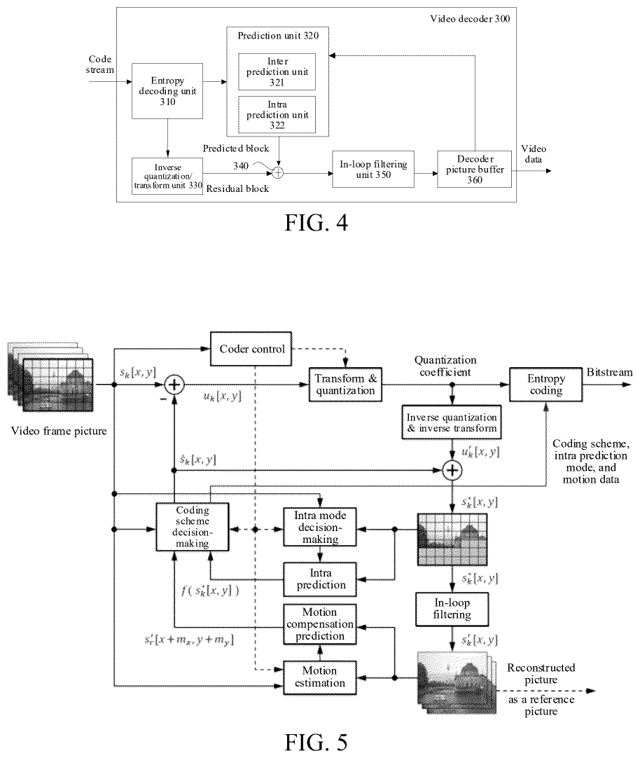

FIG. 4 is a schematic block diagram of a video decoder according to an embodiment of the present disclosure.

As shown in FIG. 4, the video decoder 300 includes an entropy decoding unit 310, a prediction unit 320, an inverse quantization/transform unit 330, a reconstruction unit 340, an in-loop filtering unit 350, and a DPB 360. The video decoder 300 may include more, fewer, or different functional components.

The video decoder 300 may receive a code stream. The entropy decoding unit 310 may parse the code stream to extract a syntax element from the code stream. As a part of parsing the code stream, the entropy decoding unit 310 may parse an entropy-coded syntax element in the code stream. The prediction unit 320, the inverse quantization/transform unit 330, the reconstruction unit 340, and the in-loop filtering unit 350 may decode video data based on the syntax element extracted from the code stream, in other words, generate decoded video data.

The prediction unit 320 includes an intra prediction unit 322 and an inter prediction unit 321.

The intra prediction unit 322 may perform intra prediction to generate a predicted block of a PU. The intra prediction unit 322 may generate the predicted block of the PU in an intra prediction mode based on a pixel block of a spatially adjacent PU. The intra prediction unit 322 may further determine the intra prediction mode for the PU based on one or more syntax elements parsed out from the code stream.

The inter prediction unit 321 may construct a first reference picture list (a list 0) and a second reference picture list (a list 1) based on the syntax element parsed out from the code stream. In addition, if the PU uses inter prediction for coding, the entropy decoding unit 310 may parse motion information of the PU. The inter prediction unit 321 may determine one or more reference blocks of the PU based on the motion information of the PU. The inter prediction unit 321 may generate a predicted block of the PU based on the one or more reference blocks of the PU.

The inverse quantization/transform unit 330 may perform inverse quantization (namely, dequantization) on a transform coefficient associated with a TU. The inverse quantization/transform unit 330 may determine a quantization degree by using a QP value associated with a CU of the TU. After performing inverse quantization on the transform coefficient, the inverse quantization/transform unit 330 may apply one or more inverse transforms to an inverse-quantized transform coefficient to generate a residual block associated with the TU.

The reconstruction unit 340 reconstructs a pixel block of the CU by using the residual block associated with the TU of the CU and the predicted block of the PU of the CU. For example, the reconstruction unit 340 may add a sample of the residual block to a corresponding sample of the predicted block to reconstruct the pixel block of the CU to obtain a reconstructed picture block.

The in-loop filtering unit 350 may perform a deblocking filtering operation to alleviate blocking artifact of pixel blocks associated with the CU.

The video decoder 300 may store a reconstructed picture of the CU in the DPB 360. The video decoder 300 may use the reconstructed picture in the DPB 360 as a reference picture for subsequent prediction, or transmit the reconstructed picture to a display apparatus for displaying the reconstructed picture.

With reference to FIG. 2 and FIG. 4, a process of video coding and decoding is as follows:

On the coder side, a frame of picture is divided into picture blocks, and for a current block, the prediction unit 210 generates a predicted block of the current block (namely, a to-be-coded block) through intra prediction or inter prediction. The residual unit 220 may calculate, based on the predicted block and an original block of the current block (namely, the to-be-coded block), a residual block, that is, a difference between the predicted block and the original block of the current block. The residual block may also be referred to as residual information. The residual block is transformed and quantized by the transform/quantization unit 230 to remove information insensitive to human eyes, to eliminate visual redundancy. In some embodiments, a residual block before being transformed and quantized by the transform/quantization unit 230 may be referred to as a time-domain residual block, and a time-domain residual block after being transformed and quantized by the transform/quantization unit 230 may be referred to as a frequency residual block or a frequency-domain residual block. The entropy coding unit 280 receives a quantized transform coefficient outputted by the transform/quantization unit 230, and may perform entropy coding on the quantized transform coefficient and output a code stream. For example, the entropy coding unit 280 may eliminate character redundancy based on a target context model and probability information of a binary code stream.

On the decoder side, the entropy decoding unit 310 may parse a code stream to obtain prediction information, a quantization coefficient matrix, and the like of a current block (namely, a to-be-decoded block). The prediction unit 320 predicts a predicted block of the current block (namely, the to-be-decoded block) based on the prediction information through intra prediction or inter prediction. The inverse quantization/transform unit 330 performs, by the quantization coefficient matrix obtained from the code stream, inverse quantization and inverse transform on the quantization coefficient matrix to obtain a residual block. The reconstruction unit 340 adds the predicted block to the residual block to obtain a reconstructed block. The reconstructed block forms a reconstructed picture, and the in-loop filtering unit 350 performs in-loop filtering on the reconstructed picture based on the picture or the block to obtain a decoded picture. The coder side also may perform an operation similar to that of the decoder side to obtain a decoded picture. The decoded picture may also be referred to as a reconstructed picture, and the reconstructed picture may be a subsequent picture used as a reference picture for inter prediction.

Block partition information determined by the coder, and mode information or parameter information of prediction, transform, quantization, entropy coding, in-loop filtering, and the like are carried in the code stream when necessary. The decoder side parses the code stream and analyzes the code stream, based on existing information to determine block partition information, and mode information or parameter information of prediction, transform, quantization, entropy coding, in-loop filtering, and the like that are the same as those of the coder side, to ensure that the decoded picture obtained by the coder is the same as the decoded picture obtained by the decoder.

Due to a requirement of parallel processing, a picture may be divided into slices or the like, and slices in a same picture may be processed in parallel, in other words, there is no data dependency between the slices. The term “frame” may be understood as a picture, a slice, or the like.

In addition, the foregoing describes a process of a video codec in a block-based coding and decoding framework. With development of technologies, some modules or operations of the framework or the process may be optimized. In other words, the present disclosure is not limited to the framework or the process.

FIG. 5 shows another example of a video coder according to the present disclosure.

As shown in FIG. 5, a difference operation is performed on an original picture signal sₖ[x,y] and a predicted picture signal ŝₖ[x,y] to obtain a residual signal uₖ[x,y], the residual signal uₖ[x,y] is transformed and quantized to obtain a quantization coefficient, the quantization coefficient is entropy-coded to obtain a coded bitstream and is inverse-quantized and inverse-transformed to obtain a reconstructed residual signal u′ₖ[x,y], and the predicted picture signal ŝₖ[x,y] and the reconstructed residual signal u′ₖ[x,y] are superposed to generate a reconstructed picture signal

$${s}_{k}^{*} [ x , y ] .$$

The reconstructed picture signal

$${s}_{k}^{*} [ x , y ]$$

is inputted to an intra mode decision-making module and an intra prediction module to perform intra prediction, and is also filtered through in-loop filtering to output a filtered picture signal s′ₖ[x,y]. The filtered picture signal s′ₖ[x,y] may be used as a reference picture for a next frame, and is configured to perform motion estimation and motion compensation prediction on the next frame. Further, prediction may be performed on the next frame based on a motion compensation prediction result s′ [x+m, y+m,] and an intra prediction result

$$f ( {s}_{k}^{*} [ x , y ] )$$

to obtain a predicted picture signal ŝₖ[x,y] of the next frame, and the foregoing process may be further repeated until coding is completed.

For ease of understanding the technical solutions provided in the present disclosure, related content is described below.

### (1) a Video Coding Technology is Briefly Described.

From the perspective of a signal obtaining manner, a video signal may be obtained in two manners: captured by a camera and generated by a computer. Different statistical characteristics may correspond to different compression and coding modes.

International video coding standards HEVC and VVC and the China national video coding standard AVS are used as an example. A hybrid coding framework is used. In the hybrid coding framework, a series of operations and processing below may be performed on an inputted original video signal:

### 1. Block Partition Structure

An input picture is divided into several non-overlapping processing units based on a size of one processing unit, and similar compression operations are performed on all of the processing units. The processing unit is referred to as a CTU or an LCU. Further, the CTU may be divided in a more fine-grained manner to obtain one or more coding units that are referred to as CUs. Each CU is an element in a coding process. The following describes various coding modes that may be used for each CU.

### 2. Predictive Coding

The predictive coding includes intra prediction, inter prediction, and the like. The original video signal undergoes prediction based on a selected reconstructed video signal to obtain a residual video signal. A coder side selects a most appropriate one of a plurality of possible predictive coding modes for a current CU, and notifies a decoder side.
a. Intra prediction: a signal for prediction is from an area that has been coded and reconstructed and that is in a same picture. A frame coded through intra prediction is an I frame. The I frame is also referred to as an intra coded frame.
b. Inter prediction: a signal for prediction is from another picture (referred to as a reference picture) that has been coded and that is different from a current picture. A frame coded through inter prediction is a P frame and a B frame. In other words, the P frame is a picture coded only using a unidirectional reference frame, and the B frame is a picture coded using a bidirectional (forward and backward) reference frame. The P frame is also referred to as a forward predictive coded frame or an inter-predictive coded frame. The B frame is also referred to as a bidirectional interpolated predictive coded frame or a bidirectional predictive coded frame.

### 3. Transform and Quantization

The residual video signal undergoes transform operations such as discrete Fourier transform (DFT) and discrete cosine transform (DCT) to convert the signal into a transform domain, where the signal is referred to as a transform coefficient. The signal in the transform domain further undergoes a lossy quantization operation to remove information to facilitate compression and expression of a quantized signal. In some video coding standards, a plurality of transform modes may be available for selection. Therefore, the coder side also may select one of the transform modes for a current CU and notify the decoder side. A granularity of quantization is usually determined by a QP. A larger value of the QP indicates that coefficients in a larger value range are to be quantized into a same output, which usually corresponds to greater distortion and a lower bit rate. On the contrary, a smaller value of the QP indicates that coefficients in a smaller value range are to be quantized into a same output, which usually corresponds to smaller distortion and a higher bit rate.

### 4. Entropy Coding or Statistical Coding

A quantized transform-domain signal undergoes statistical compression and coding based on appearance frequency of each value, and a binary (0 or 1) compressed code stream is finally outputted. In addition, entropy coding also may be performed on other information generated through coding, such as a selected mode and a motion vector, to reduce a bit rate. The statistical coding is a lossless coding mode that can effectively reduce a bit rate needed for expressing a same signal. The statistical coding mode usually includes variable length coding (VLC) and content adaptive binary arithmetic coding (CABAC).

### 5. In-Loop Filtering

A coded picture may undergo inverse quantization, inverse transform, and predictive compensation operations to obtain a reconstructed decoded picture. Compared with an original picture, due to impact of quantization, the reconstructed picture includes some information different from that of the original picture, leading to distortion. Performing a filtering operation, for example, by using a DBF, SAO, or ALF, on the reconstructed picture can effectively reduce the distortion caused by the quantization. These filtered reconstructed pictures are to be stored in a DPB as references for subsequent coded pictures, to perform prediction on future signals. Therefore, the foregoing filtering operation is also referred to as in-loop filtering, to be specific, a filtering operation in a coding loop.

According to the foregoing coding process, after the decoder obtains a compressed code stream for each CU, the decoder side first performs entropy decoding to obtain various mode information and quantized transform coefficients. The coefficients are inverse-quantized and inverse-transformed to obtain a residual signal. In addition, a predicted signal corresponding to the CU may be obtained based on known coding mode information, and the predicted signal may be added to the residual signal to obtain a reconstructed signal. Finally, a reconstructed value of the decoded picture may undergo an in-loop filtering operation to generate a final output signal. In this series of coding processes, the coding framework evaluates and selects an optimal coding parameter and result mainly according to a rate distortion optimization (RDO) criterion.

### (2) CTU

Each frame of picture in a video is first segmented into units of a specific size, and then undergoes a subsequent coding and decoding process.

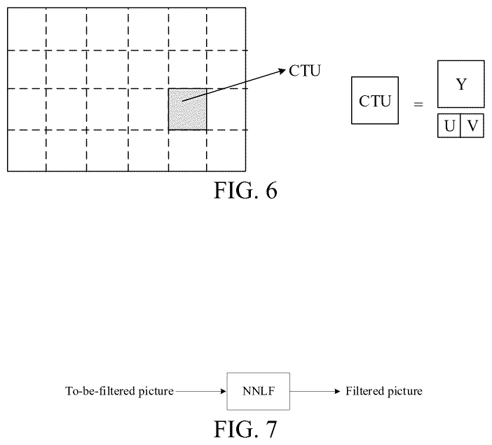

FIG. 6 is a schematic structural diagram of a CTU according to the present disclosure.

As shown in FIG. 6, the CTU is a coding unit in the hybrid coding framework, and usually includes two parts: luminance Y and chrominance UV To be specific, each CTU includes one luminance CTB, two chrominance CTBs, and a syntax element. For example, a picture with a YUV ratio of 4:2:0 is used as an example. The picture is divided into a plurality of CTUs. It is assumed that a size of the CTU is 16×16, the CTU includes one 16×16 luminance CTB and two 8×8 chrominance CTBs. In other words, because the picture is sampled at 4:2:0, a size of the luminance CTB is four times that of the chrominance CTB.

### (3) NNLF

In the hybrid coding framework, a in-loop filter is used to suppress distortion of a reconstructed picture, to improve quality of the reconstructed picture, and to restore a coded reconstructed picture to an original picture. However, the in-loop filter is manually designed, making it difficult to effectively alleviate the distortion of the reconstructed picture, and leaving a large optimization space. Because deep learning tools have excellent performance in picture processing, a deep learning-based in-loop filter is applied to the in-loop filter.

The present disclosure mainly relates to a technology of performing filtering by using the NNLF.

FIG. 7 is a schematic diagram of a filtering principle of an NNLF according to an embodiment of the present disclosure.

As shown in FIG. 7, a to-be-filtered picture before filtering is inputted to a trained NNLF to obtain a filtered augmented picture, namely, a filtered picture.

The NNLF usually uses a loss function to constrain the filtered picture, so that the filtered picture can be restored to an original picture as much as possible. The loss function measures a difference between a predicted value and a true value. A larger loss value of the NNLF indicates a larger difference. A training objective is to reduce the loss value of the NNLF. A common loss function for a deep learning-based coding tool includes an L1 norm loss function, an L2 norm loss function, and a smooth L1 loss function.

In addition, a temporal NNLF may be constructed by using time-domain information (for example, a reference picture).

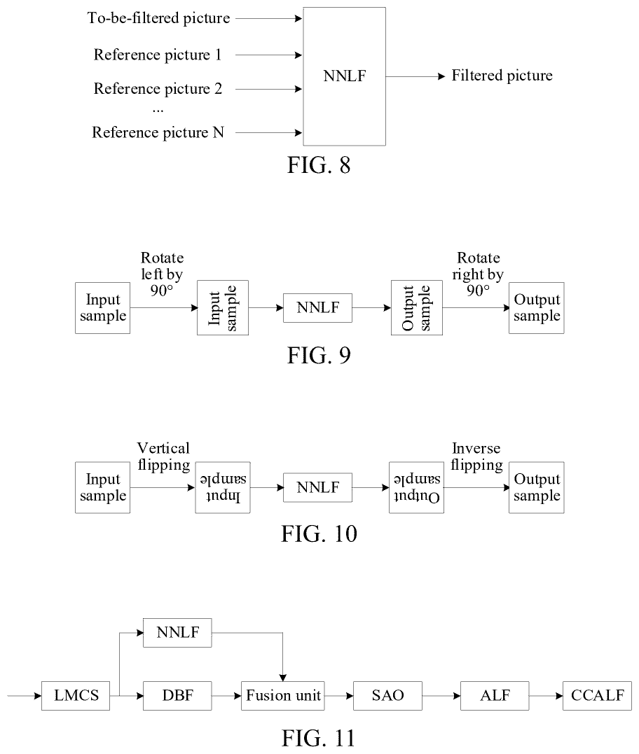

FIG. 8 is a schematic diagram of a filtering principle of a temporal NNLF according to an embodiment of the present disclosure.

As shown in FIG. 8, a to-be-filtered picture before filtering and N reference pictures (that is, a reference picture 1 to a reference picture N) are inputted to a trained temporal NNLF to obtain a filtered augmented picture, namely, a filtered picture. N is a positive integer greater than or equal to 1.

### (4) Picture Evaluation Indicator

The picture evaluation indicator usually includes a peak signal-to-noise ratio (PSNR) and a multi-scale structural similarity index measure (MS-SSIM).

The PNSR is a common objective criterion for evaluating a picture, and is configured to calculate a visual error between two pictures. For example, during video coding, the PSNR is configured to measure a pixel difference between a compressed picture and an original picture. A larger value of the PNSR is better.

For example, given a denoised picture I and a noise picture K with a size of m×n, a formula for calculating a PSNR of pictures is as follows:

$$PNSR = 10 * {log}_{10} ( \frac{{MAX}^{2}}{MSE} ) .$$

MAX represents a maximum pixel value in a picture, and MSE is defined as follows:

$$MSE = \frac{1}{mn} {\sum }_{i = 0}^{m - 1} {\sum }_{j = 0}^{n - 1} {( I ( i , j ) - K ( i , j ) )}^{2} .$$

The MS-SSIM is a widely used picture quality evaluation criterion, and is configured to measure a structural similarity between pictures, including a difference in luminance, contrast, and structure. An evaluation result of the MS-SSIM is closer to a subjective quality evaluation result of human eyes.

For example, for samples x and y, a calculation formula for the MS-SSIM is as follows:

$$MS - SSIM ( x , y ) = {[ {l}_{M} ( x , y ) ]}^{{α}_{M}} * {{\prod }_{j = 1}^{M} [ {c}_{j} ( x , y ) ]}^{{β}_{j}} * {[ {s}_{j} ( x , y ) ]}^{{γ}_{j}} .$$

cⱼ(x,y) and sⱼ(x,y) respectively represent contrast measurement and structure measurement at different scales, and l(x,y) represents luminance measurement at the last scale. α_{M}, βⱼ, and γⱼ are configured to adjust importance of different components. M represents a quantity of scales.

### (5) QP Adjustment Policy (QP Offset Adjustment)

A prediction structure with hierarchical B frames is used in video coding. In this prediction structure, a video sequence is divided into a plurality of groups of pictures (GOPs), and each GOP includes one key frame (an I frame or a P frame) and a group of non-key frames (B frames). For example, one GOP includes eight frames, the first seven frames are non-key B frames, and the last frame is a key I frame or P frame.

In the hierarchical prediction structure, the non-key B frames may be divided into different temporal layers (TLs), and a B frame at an upper TL may use a coded frame at a lower TL as a reference.

In the hierarchical prediction structure, a coding order and a display order of pictures are independent of each other. A coding order and a display order of key frames are the same. Non-key frames are coded in ascending order of TLs to which the non-key frames belong, or are coded according to a binary tree depth traversal order, and are displayed according to an actual order of pictures.

The prediction structure with hierarchical B frames has good time-domain scalability. In the prediction structure with hierarchical B frames, a sequence including all key frames has the lowest time-domain resolution. With an increase in a quantity of time-domain layers, the time-domain resolution of the sequence gradually increases. To be specific, time-domain pixel density increases, details of a picture are more abundant, and a picture is finer. On this basis, because picture quality of a to-be-filtered picture inputted to an NNLF during training fluctuates within a small range, but the prediction structure with hierarchical B frames causes an increase in time-domain pixel density of the to-be-filtered picture and further leads to an increase in a fluctuation range of the picture quality of the to-be-filtered picture, it is difficult to keep quality of an input picture (especially the to-be-filtered picture) of the NNLF consistent during training and testing. In the present disclosure, the QP adjustment policy is introduced to keep the quality of the input picture of the NNLF as consistent as possible during training and testing. An input of the NNLF usually includes a base QP and a slice QP. In addition, different QP inputs make the NNLF sense inputs differently, and therefore the NNLF generates different filtering results. To improve adaptability of the NNLF, different QP offsets may be added to the input base QP. A quantization offset candidate list is {0, −5, +5}.

For example, a decoder may determine, based on a decoding flag, whether to use the QP adjustment policy or a QP offset to be used. Exemplary descriptions are provided below with reference to Table 1 and Table 2.

TABLE 1

| QP offset | Bit | Meaning |
|---|---|---|
| 0 | 0 | No QP offset is to be used. |
| −5 | 10 | A QP offset to be used is −5. |
| +5 | 11 | A QP offset to be used is +5. |

As shown in Table 1, a coder may indicate, using (different values of) one flag, whether not to use any QP offset, a QP offset of −5, or a QP offset of +5. For example, a value of the flag being 10 indicates that a QP offset to be used is −5.

TABLE 2

| QP offset | Bit | Meaning |
|---|---|---|
| 0 | 0 | No QP offset is to be used. |
| −5/+5 | 1 | A QP offset used for a frame/block (TID <4) |
| | | at a lower time-domain layer is −5, and a QP |
| | | offset used for a frame/block (TID ≥4) at an |
| | | upper time-domain layer is +5. |

As shown in Table 2, the decoder may indicate the following two cases by decoding (different values of) one flag: Case 1: No QP offset is to be used. Case 2: A QP offset used for a frame/block (TID<4) at a lower time-domain layer is −5, and a QP offset used for a frame/block (TID>4) at an upper time-domain layer is +5. For example, a value of the flag being 0 indicates Case 1, and a value of the flag being 1 indicates Case 2.

### (6) Rotation/Flipping Policy for Input and Output

Similar to the QP adjustment policy, to further improve filter adaptability of the NNLF, a network input may be adaptively rotated/flipped, and then a network output is inverse-rotated/flipped to obtain a better filtering result based on RDO decision-making. The rotation/flipping policy for input and output may also be referred to as a geometric transform policy or a transform policy for short.

FIG. 9 shows an example of a rotation principle of a rotation mode in a transform policy according to an embodiment of the present disclosure.

As shown in FIG. 9, an input sample may be rotated left by 90° to obtain a rotated input sample. The NNLF may use the rotated input sample as an input and obtain an output sample, and then rotate the output sample right by 90° to obtain a rotated output sample. The rotated output sample is a filtered sample obtained by using the transform policy.

FIG. 10 shows an example of a flipping principle of a flipping mode in a transform policy according to an embodiment of the present disclosure.

As shown in FIG. 10, an input sample may be flipped in a vertical flipping mode to obtain a flipped input sample. The NNLF may use the flipped input sample as an input and obtain an output sample, and then perform inverse flipping on the output sample to obtain an inverse-flipped output sample. The inverse-flipped output sample is a filtered sample obtained by the transform policy.

For example, a decoder may determine, based on a decoding flag, whether to use a transform policy or a transform mode. Exemplary descriptions are provided below with reference to Table 3.

TABLE 3

| Transform mode | Bit |
|---|---|
| No transform policy is to be enabled. | 0 |
| Rotate left by 90°. | 10 |
| Rotate right by 90°. | 11 |

As shown in Table 3, a coder may indicate, using (different values of) one flag, whether not to enable the transform policy, to use the transform mode of rotating left by 90°, or to use the transform mode of rotating right by 90°. For example, a value of the flag being 10 indicates that a transform mode to be used rotates left by 90°.

### (7) Scale Factor Fusion Policy

A better filtering result can usually be obtained by fusing a filtering result of the NNLF and a filtering result of a filter based on a scale factor. The scale factor fusion policy may also be referred to as a fusion policy for short.

FIG. 11 shows an example of a fusion principle of a fusion policy according to an embodiment of the present disclosure.

As shown in FIG. 11, in neural network-based video coding (NNVC), an output of luma mapping with chroma scaling (LMSC) is used as an input of an NNLF and a DBF, a fusion unit fuses a filtering result of the NNLF and a filtering result of the DBF based on different scale factors, and a selected filtering result is obtained through RDO selection. The selected filtering result may sequentially pass through filters such as an SAO filter, an ALF, and a cross component ALF (CCALF), to obtain a final filtering result.

For example, the fusion policy may be implemented by using the following fusion formula:

R_{Blend}=w×R_{NN}+(1−w)×R_{DBF}.

R_{Blend} represents a final result obtained through fusion, R_{NN} represents a filtering result of the NNLF, R_{DBF} represents a filtering result of a filter DBF, and w represents a scale factor used for fusion.w usually has four possible values/modes: {adaptive weight, 1, 0.75, 0.5}. The adaptive weight is obtained through a calculation based on each filtering result of the NNLF and a result of the filter, and the adaptive weight is not a fixed value.

For example, a decoder may determine, based on a decoding flag, whether to use the fusion policy or a scale factor. Exemplary descriptions are provided below with reference to Table 4.

TABLE 4

| Fusion mode | Bit | Meaning |
|---|---|---|
| −1 | 0 | No fusion policy is to be used. |
| 0 | 100 | The adaptive weight is to be used. |
| 1 | 101 | A weight to be used is 1. |
| 2 | 110 | A weight to be used is 0.75. |
| 3 | 111 | A weight to be used is 0.5. |

As shown in Table 4, a coder may indicate, using (different values of) one flag, whether not to use the fusion policy, to use the adaptive weight, to use the weight of 1, to use the weight of 0.75, or to use the weight of 0.5. For example, a value of the flag being 110 indicates to use the weight of 0.75, in other words, the scale factor is 0.75.

A technical problem to be resolved in the present disclosure is described below.

In NNVC, a neural network filter is designed as an additional filter to improve coding performance. To further improve coding performance of an NNLF, performance of the neural network filter may be enhanced based on various information processing policies. The information processing policy may include the foregoing QP offset adjustment policy, a geometric transform policy for input and output (for example, the rotation/flipping policy for input and output), the scale factor fusion policy, and the like. However, when these information processing policies are used, a coder may code a related flag (including one or more bits), and a flag used by each information processing policy is independent. This leads to the following two problems.

In a first aspect, the coder cannot enhance the performance of the neural network filter by combining a plurality of information processing policies. In other words, when the performance of the neural network filter is enhanced by independently using the plurality of information processing policies, enhancement effect achieved when the information processing policies are used independently is weaker than enhancement effect achieved when the information processing policies are combined. That is, the performance of the neural network filter is not globally optimized.

For example, for a to-be-filtered unit, when enhancing the performance of the neural network filter by independently using the QP offset adjustment policy, the coder selects −5 from the quantization offset candidate list as a to-be-used QP offset, to achieve best enhancement effect; and when enhancing the performance of the neural network filter by independently using the transform policy, the coder selects rotating left by 90° from various transform modes as a to-be-used transform mode to achieve best enhancement effect. However, when both the QP offset adjustment policy and the transform policy are used, the QP offset of −5 and the transform mode of rotating left by 90° may not be an optimal combination.

In a second aspect, when enhancing the performance of the neural network filter by independently using a plurality of information processing policies, the coder may independently code a flag related to each of the information processing policies. Consequently, an excessively large quantity of flags or bits are introduced when the performance of the neural network filter is enhanced using the plurality of information processing policies, thereby degrading decoding efficiency and decoding performance.

The present disclosure provides a filtering method. The performance of the neural network filter is enhanced by combining a plurality of information processing policies. This can not only improve filtering performance of the neural network filter, but also improve filtering effect of a to-be-filtered picture. This further helps jointly design flags related to the plurality of information processing policies, and further helps reduce a quantity of flags or bits introduced when the performance of the neural network filter is enhanced using the plurality of information processing policies, thereby improving decoding efficiency and decoding performance. In addition, the present disclosure further provides a filtering method (i) to optimize a level of a to-be-filtered unit filtered by using an information processing policy, (ii) to control bits occupied by flags related to different information processing policies, and (iii) to improve decoding efficiency and decoding performance.

The filtering method provided in the present disclosure is described below in detail.

The filtering method provided in the present disclosure may be applied to a video coder, a codec, or a video pre-processing or post-processing product.

For example, if the filtering method provided in the present disclosure may be applied to a video coder or a video decoder, a general-purpose neural network filter may be used as an in-loop filter (a filter output affects video coding and decoding).

If the filtering method is applied to a video coding solution, when coding a current picture, a coder side first divides the current picture into coding blocks and performs block-wise coding using the coding block as a CU. For example, for a to-be-coded current block in the current picture, a predicted value of the current block is first obtained through inter prediction and/or intra prediction. Then, a residual value of the current block is obtained based on the predicted value of the current block and the current block. The coder side transforms the residual value of the current block to obtain a transform coefficient. In an example, the coder side does not quantize the transform coefficient of the current block, and directly codes the transform coefficient to obtain a code stream. In another example, the coder side quantizes the transform coefficient of the current block to obtain a quantized coefficient, and then codes the quantized coefficient to obtain a code stream. In addition, the coder side further performs inverse quantization (when quantization is not performed during coding, inverse quantization may alternatively not be performed) and inverse transform on the transform coefficient to obtain a residual value, and adds the residual value to the predicted value to obtain a reconstructed value of the current block.

Based on the foregoing operations, reconstructed values of all coding blocks in the current picture may be obtained, and these reconstructed values form a reconstructed picture of the current picture. Then, to further improve quality of the reconstructed picture, the coder side may filter the reconstructed picture or a reconstructed picture block in the reconstructed picture using the filtering method provided in the present disclosure to obtain a decoded picture of the current picture. The coder side may alternatively store the decoded picture in a decoding buffer for subsequent picture prediction.

If the filtering method is applied to a video decoding solution, for each to-be-decoded block, for example, a current block, in a current picture, after obtaining a code stream, a decoder side decodes the code stream to obtain a transform coefficient of the current block. Then, the decoder side performs inverse quantization (when quantization is not performed during coding, inverse quantization may alternatively not be performed) and inverse transform on the transform coefficient of the current block to obtain a residual value of the current block. In addition, the decoder side obtains a predicted value of the current block through inter prediction and/or intra prediction. In this way, the predicted value and the residual value of the current block are added up to obtain a reconstructed value of the current block. Based on the foregoing operations, the decoder side may determine, through decoding, reconstructed values of all to-be-decoded blocks in the current picture, and these reconstructed values form a reconstructed picture of the current picture. Then, to further improve quality of the reconstructed picture, the decoder side may filter the reconstructed picture or a reconstructed picture block in the reconstructed picture end using the filtering method provided in the present disclosure to obtain a decoded picture of the current picture. The decoder side may store the decoded picture in a decoding buffer for subsequent picture prediction. In addition, the decoder side may output the decoded picture to a display device for displaying the decoded picture.

For another example, if the filtering method provided in the present disclosure may be applied to a video post-processing product, filtering optimization (a filter output does not affect video decoding) may be performed on a decoded video.

In addition, the filtering method provided in the present disclosure may also be applied to any module that uses a neural network during NNVC, for example, a neural network super-resolution module. In addition, the filtering method provided in the present disclosure may be applied not only to an inference process of NNVC, but also to a training process of a neural network filter. To be specific, one or more optimal data processing modes may be used in the training process of the neural network filter for training, and one or more optimal data processing modes are still used in a testing process for testing, to ensure consistency between the training process and the testing process, and further ensure filtering performance of the neural network filter.

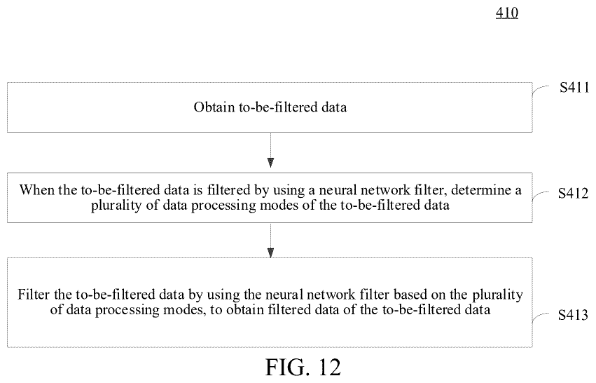

FIG. 12 is a schematic flowchart of a filtering method 410 according to the present disclosure.

The filtering method 410 may be performed by a filtering apparatus. For example, the filtering method 410 may be performed by a filtering apparatus in the decoding device 120 or the decoder 122 shown in FIG. 1. For another example, the filtering method 410 may be performed by a filtering apparatus in the video decoder 300 shown in FIG. 4. For ease of description, the filtering method 410 is described below using a filtering apparatus as an example.

As shown in FIG. 12, the filtering method 410 may include at least some or all of the following operations:

s411: Obtain to-be-filtered data.

For example, the to-be-filtered data may be a unit of any type or any size that is obtained through decoding by the decoder and that may be filtered, and may include a picture, a picture block, an audio block, or another unit for signal processing. These units are usually compressed and coded in a coding process, and the decoder may decode and decompress the units, and then perform subsequent processing such as filtering.

For example, the to-be-filtered data may be a to-be-filtered picture or a to-be-filtered picture block. The to-be-filtered picture may be a reconstructed picture, and the to-be-filtered picture block may be a partial area of the to-be-filtered picture.

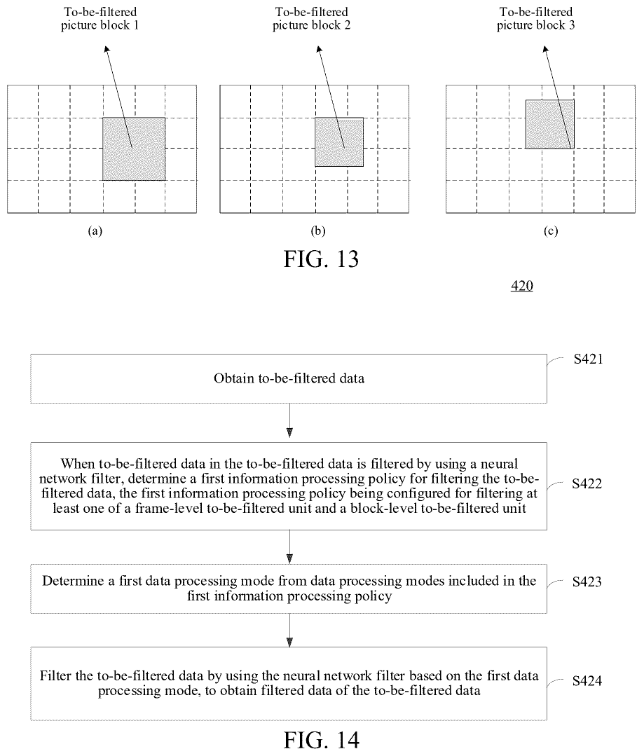

FIG. 13 shows an example of a to-be-filtered picture block according to an embodiment of the present disclosure.

As shown in FIG. 13, the to-be-filtered picture block may include L CTUs (for example, L is a positive integer) or an area of a random size. For example, as shown in (a) in FIG. 13, the to-be-filtered picture block may include four CTUs. For another example, as shown in (b) in FIG. 13, the to-be-filtered picture block may be an area whose upper left corner overlaps an upper left corner of a CTU and whose size is greater than that of one CTU. For another example, as shown in (c) in FIG. 13, the to-be-filtered picture block may be an area whose upper right corner overlaps an upper right corner of a CTU and whose size is greater than that of one CTU.

S412: When the to-be-filtered data is filtered using a neural network filter, determine a plurality of data processing modes of the to-be-filtered data.

For example, the filtering apparatus may determine the plurality of data processing modes based on a plurality of information processing policies.

For example, any one of the plurality of information processing policies is an information processing policy for enhancing performance of the neural network filter. To be specific, when filtering to-be-filtered data using the neural network filter, the filtering apparatus may first determine the plurality of information processing policies for enhancing the performance of the neural network filter, and then filter the to-be-filtered data using the neural network filter based on the plurality of information processing policies.

For example, any one of the plurality of information processing policies may include one or more data processing modes.

For example, the data processing mode in the information processing policy may be configured to perform information processing on to-be-processed information. The to-be-processed information includes at least one of the following: information in the to-be-filtered data, and filtered data outputted after the to-be-filtered data is filtered by the neural network filter. After undergoing information processing, to-be-processed information in the information in the to-be-filtered data may be used as input information of the neural network filter. After undergoing information processing, filtered data outputted by the neural network filter after filtering may be used as filtered data obtained through further filtering.

For example, the plurality of information processing policies include at least one of the following policies: a QP adjustment policy for adjusting a QP of the to-be-filtered data, a transform policy for performing geometric transform on the to-be-filtered data, and a fusion policy for fusing the filtered data outputted by the neural network filter and filtered data outputted by a filter other than the neural network filter, when the plurality of information processing policies include the QP adjustment policy, a data processing mode among the plurality of data processing modes that belongs to the QP adjustment policy including a QP adjustment value for adjusting the QP; or when the plurality of information processing policies include the transform policy, a data processing mode among the plurality of data processing modes that belongs to the transform policy including a transform mode for performing geometric transform on the to-be-filtered data; or when the plurality of information processing policies include the fusion policy, a data processing mode among the plurality of data processing modes that belongs to the fusion policy including a scale factor of the filtered data outputted by the neural network filter.

For example, the transform mode for performing geometric transform on the to-be-filtered data includes but is not limited to: rotating left by N×90°, rotating right by N×90°, horizontally flipping, vertically flipping, and the like.

For related content regarding the QP adjustment policy, the transform policy, and the fusion policy, reference is made to the foregoing descriptions. To avoid repetition, the details are not reiterated herein.

For example, the plurality of information processing policies may include any two of the QP adjustment policy, the transform policy, and the fusion policy. For example, the plurality of information processing policies may include the QP adjustment policy and the transform policy, or the plurality of information processing policies may include the QP adjustment policy and the fusion policy.

For example, the plurality of information processing policies may include the QP adjustment policy, the transform policy, and the fusion policy.

In an alternative embodiment, the plurality of information processing policies may further include a policy of another type or any policy proposed in a future technology for enhancing the performance of the neural network filter. This is not limited in the present disclosure.

For example, the plurality of information processing policies and the plurality of data processing modes may be in a one-to-one correspondence.

For example, one data processing mode may be determined in each of the plurality of information processing policies to obtain the plurality of data processing modes. In other words, different data processing modes among the plurality of data processing modes may belong to different information processing policies among the plurality of information processing policies.

For example, the plurality of information processing policies and the plurality of data processing modes may be in a one-to-many relationship.

For example, one or more data processing modes may be determined in each of the plurality of information processing policies to obtain the plurality of data processing modes. For example, when any one of the plurality of information processing policies includes a plurality of information processing sub-policies, one or more data processing modes may be determined in each sub-policy of the any information processing policy to obtain the plurality of data processing modes. For example, the any information processing policy may be a transform policy, and the transform policy may include a rotation sub-policy and a flipping sub-policy. The any information processing policy may alternatively be a policy of another type. This is not limited in the present disclosure.

For example, when a plurality of data processing modes are determined from data processing modes included in the plurality of information processing policies, a plurality of mode combinations obtained by combining data processing modes in different information processing policies among the plurality of information processing policies may be first obtained, then a mode combination is selected from the plurality of mode combinations, and data processing modes included in the selected mode combination are determined as the plurality of data processing modes.

S413: Filter the to-be-filtered data using the neural network filter based on the plurality of data processing modes to obtain filtered data of the to-be-filtered data.

For example, when the plurality of information processing policies include a first type of information processing policy for performing information processing on information in the to-be-filtered data, the plurality of data processing modes include a data processing mode in the first type of information processing policy. In this case, the filtering apparatus may process to-be-processed information in the to-be-filtered data based on the data processing mode in the first type of information processing policy, replace the to-be-processed information in the to-be-filtered data with information obtained through processing, and use to-be-filtered information obtained through replacement as input information to the neural network filter.

For example, when the plurality of information processing policies include the QP adjustment policy, a data processing mode among the plurality of data processing modes that belongs to the QP adjustment policy includes a QP adjustment value for adjusting the QP. In this case, the filtering apparatus may adjust the QP of the to-be-filtered data based on the QP adjustment value to obtain an adjusted QP, and replace the QP in the to-be-filtered data with the adjusted QP to obtain input information of the neural network filter.

For another example, when the plurality of information processing policies include the transform policy, a data processing mode among the plurality of data processing modes that belongs to the transform policy includes a transform mode for performing geometric transform on the to-be-filtered data. Assuming that the transform mode for performing geometric transform on the to-be-filtered data is denoted as a first transform mode, the filtering apparatus may perform geometric transform on the to-be-filtered data based on the first transform mode to obtain a transformed filtering unit, and replace the to-be-filtered data in the to-be-filtered data with the transformed filtering unit to obtain input information of the neural network filter. In addition, the filtering apparatus further may perform, based on an inverse transform mode corresponding to the first transform mode, inverse geometric transform on the filtered data outputted by the neural network filter.

For example, when the plurality of information processing policies include a second type of information processing policy for performing information processing on the filtered data outputted by the neural network filter, the plurality of data processing modes include a data processing mode in the second type of information processing policy. In this case, the filtering apparatus may perform, based on the data processing mode in the second type of information processing policy, information processing on the filtered data outputted by the neural network filter.

For example, when the plurality of information processing policies include the fusion policy, a data processing mode among the plurality of data processing modes that belongs to the fusion policy includes a scale factor of the filtered data outputted by the neural network filter. In this case, the filtering apparatus may fuse, based on the scale factor, the filtered data outputted by the neural network filter and filtered data outputted by another filter, for example, perform, based on the scale factor, weighted calculation on the filtered data outputted by the neural network filter and the filtered data outputted by the another filter to obtain fused filtered data.

S413 is described below by using an example in which the plurality of information processing policies include the QP adjustment policy and the transform policy.

For example, when the plurality of information processing policies include the QP adjustment policy and the transform policy, a data processing mode among the plurality of data processing modes that belongs to the QP adjustment policy includes a QP adjustment value for adjusting the QP, and a data processing mode among the plurality of data processing modes that belongs to the transform policy includes a transform mode for performing geometric transform on the to-be-filtered data. In this case, the filtering apparatus may adjust the QP of the to-be-filtered data based on the QP adjustment value to obtain an adjusted QP. In addition, assuming that the transform mode for performing geometric transform on the to-be-filtered data is denoted as a first transform mode, the filtering apparatus may perform geometric transform on the to-be-filtered data based on the first transform mode to obtain a transformed filtering unit; and then the filtering apparatus replaces the QP in the to-be-filtered data with the adjusted QP, and replaces the to-be-filtered data in the to-be-filtered data with the transformed filtering unit, to obtain input information of the neural network filter. In addition, the filtering apparatus further may perform, based on an inverse transform mode corresponding to the first transform mode, inverse geometric transform on the filtered data outputted by the neural network filter.

When a coder side traverses a candidate list {0, −5, +5} of QP offset adjustment amounts (a QP offset is an integer), and when the QP offset adjustment policy is enabled, in other words, a selected QP adjustment amount is not 0, the coder side performs geometric transform on the to-be-filtered data by default, and performs inverse transform on a corresponding output to restore the output to an original geometric form. A decoder side may directly parse a code stream to obtain a QP adjustment amount and a transform mode that are used. For example, the transform mode may be any one of the following modes: rotating left by N×90°, rotating right by N×90°, horizontally flipping, and vertically flipping.

Essentially, both the QP adjustment policy and the transform policy are intended to ensure consistency of inputs of the neural network filter during training and testing. Therefore, the QP adjustment policy and the transform policy are combined to maximally keep inputs of the neural network filter consistent during training and testing.

S413 is described below using an example in which the plurality of information processing policies include the QP adjustment policy and the fusion policy.

For example, when the plurality of information processing policies include the QP adjustment policy and the fusion policy, a data processing mode among the plurality of data processing modes that belongs to the QP adjustment policy includes a QP adjustment value for adjusting the QP, and a data processing mode among the plurality of data processing modes that belongs to the fusion policy includes a scale factor of the filtered data outputted by the neural network filter. In this case, the filtering apparatus may adjust the QP of the to-be-filtered data based on the QP adjustment value to obtain an adjusted QP, and replace the QP in the to-be-filtered data with the adjusted QP to obtain input information of the neural network filter. In addition, the filtering apparatus may fuse, based on the scale factor, the filtered data outputted by the neural network filter and filtered data outputted by another filter, for example, perform, based on the scale factor, weighted calculation on the filtered data outputted by the neural network filter and the filtered data outputted by the another filter to obtain fused filtered data.

The coder side first performs QP offset processing by using the neural network filter to obtain filtering results at different QP offsets, then performs different scale factor fusion processing based on the obtained different filtering results, and finally selects an optimal QP offset and a scale factor thereof through RDO decision-making. The decoder side may directly parse a code stream to obtain a finally used QP offset and a scale factor thereof.

In this embodiment, when the to-be-filtered data in the to-be-filtered data is filtered by using the neural network filter, the plurality of data processing modes for filtering the to-be-filtered data first need to be determined, and then the to-be-filtered data is filtered using the neural network filter based on the plurality of data processing modes to obtain the filtered data of the to-be-filtered data. This is equivalent to enhancing the performance of the neural network filter by combining a plurality of data processing modes determined from the plurality of data processing modes, so that filtering performance of the neural network filter can be improved, thereby improving filtering effect of a to-be-filtered picture. This further helps jointly design flags related to the plurality of data processing modes, and further helps reduce a quantity of flags or bits introduced when the performance of the neural network filter is enhanced using the plurality of data processing modes, thereby improving decoding efficiency and decoding performance.

In some embodiments, when the plurality of data processing modes form a first mode combination, the first mode combination is a mode combination with a smallest filtering cost among a plurality of mode combinations.

For example, the plurality of mode combinations include mode combinations obtained by combining data processing modes in different information processing policies among the plurality of information processing policies.

For example, the plurality of mode combinations may be mode combinations obtained by combining one or more data processing modes in each of a plurality of policy combinations. For example, the plurality of mode combinations may be mode combinations obtained by combining one data processing mode in each of the plurality of policy combinations. To be specific, any one of the plurality of mode combinations includes one data processing mode in each of the plurality of information processing policies.

From the perspective of the decoder, a filtering apparatus in the decoder may determine the plurality of data processing modes by decoding a code stream. To be specific, when the plurality of data processing modes obtained by the filtering apparatus through decoding form a first mode combination, the first mode combination is a mode combination with a smallest filtering cost among the plurality of mode combinations, and the plurality of mode combinations include mode combinations obtained by combining data processing modes in different information processing policies among the plurality of information processing policies.

For example, it is assumed that the plurality of information processing policies include a policy A and a policy B, the policy A includes a mode A1 and a mode A2, and the policy B includes a mode B1, a mode B2, and a mode B3. In this case, the plurality of mode combinations may include the following six combinations: a mode combination 1: the mode A1 of the policy A+the mode B1 of the policy B; a mode combination 2: the mode A1 of the policy A+the mode B2 of the policy B; a mode combination 3: the mode A1 of the policy A+the mode B3 of the policy B; a mode combination 4: the mode A2 of the policy A+the mode B1 of the policy B; a mode combination 5: the mode A2 of the policy A+the mode B2 of the policy B; and a mode combination 6: the mode A2 of the policy A+the mode B3 of the policy B.

From the perspective of the coder, a filtering apparatus in the coder may directly determine a mode combination with a smallest cost among the plurality of mode combinations, and determine data processing modes in the mode combination with the smallest cost as the plurality of data processing modes. The plurality of mode combinations may be mode combinations obtained by combining one data processing mode in each of the plurality of policy combinations.

The filtering apparatus in the coder may alternatively first determine to-be-used information processing policies, namely, the plurality of information processing policies, from a plurality of candidate policies; and then determine to-be-used data processing modes, namely, the plurality of data processing modes, in the plurality of information processing policies.

For example, the filtering apparatus may first obtain the plurality of candidate policies, and then determine a filtering cost of a mode combination of each of a plurality of policy combinations. The plurality of policy combinations include a policy combination obtained by combining the plurality of candidate policies, and the mode combination of each policy combination includes a mode combination obtained by combining data processing modes in different candidate policies in the policy combination. In this way, a mode combination with a smallest cost may be determined based on the filtering cost of the mode combination of each policy combination, information processing policies to which data processing modes in the mode combination with the smallest cost belong are determined as the plurality of information processing policies, and the data processing modes in the mode combination with the smallest cost are determined as the plurality of data processing modes.

Certainly, regardless of a combination form of the plurality of mode combinations, understanding of the coder side and the decoder side on the plurality of mode combinations may keep consistent. For example, the plurality of mode combinations may be combinations agreed upon in a protocol, or the plurality of mode combinations may be information notified by the coder side (for example, by using one or more flags) to the decoder side.

In this embodiment, when the plurality of data processing modes form the first mode combination, the first mode combination is a mode combination with a smallest filtering cost among the plurality of mode combinations. This is equivalent to selecting an optimal mode combination from the plurality of mode combinations for enhancing the performance of the neural network filter, so that the neural network filter can be better generalized, to improve filtering performance of the neural network filter, and further improve filtering effect of the to-be-filtered picture.

In some embodiments, the filtering cost is determined based on at least one of the following indicators: a PSNR, an MS-SSIM, and an RDO cost.

In this embodiment, after the performance of the neural network filter is enhanced by using different mode combinations, filtered pictures corresponding to mode combinations are obtained. Determining the filtering cost based on the PSNR or the MS-SSIM is equivalent to considering differences between content characteristics and quality levels of the filtered pictures corresponding to the mode combinations. Determining the filtering cost based on the RDO is equivalent to adaptively selecting an optimal mode combination from the plurality of mode combinations for enhancing the performance of the neural network filter. In this way, the neural network filter can be better generalized to improve filtering performance of the neural network filter, and further to improve filtering effect of the to-be-filtered picture.

For example, the filtering cost is a cost determined based on the PSNR and the MS-SSIM.

In this embodiment, the filtering cost is determined based on the PSNR and the MS-SSIM. To be specific, filtering costs of filtered pictures corresponding to mode combinations may be determined based on the PSNR and the MS-SSIM, and then an optimal mode combination is determined based on the filtering costs of the filtered pictures corresponding to the mode combinations. In this way, determining an optimal mode combination through a complex RDO selection process can be skipped, to improve filtering efficiency.

For example, the filtering cost may be determined using the following formula:

Scoreᵢ=PSNRᵢ+λ*MS−SSIMᵢ.

i represents an i^{th} mode combination of the plurality of mode combinations. PSNRᵢ represents a quality level of a filtered picture corresponding to the i^{th} mode combination. MS-SSIM represents a content difference between the filtered picture corresponding to the i^{th} mode combination and a to-be-filtered picture to which the to-be-filtered data belongs. A is a weight factor for balancing PSNRᵢ and MS−SSIMᵢ.

Certainly, in an alternative embodiment, the PSNR or the MS-SSIM may alternatively be replaced with another evaluation indicator, for example, including but not limited to: a sum of absolute differences (SAD), a sum of absolute transformed differences (SATD), a sum of squares for error (SSE), and a mean square error (MSE). Alternatively, the filtering cost may be determined only by using the PSNR, the MS-SSIM, or another indicator. This is not limited in the present disclosure.

In some embodiments, S412 may include: decoding a code stream to obtain a first flag, the first flag being configured to indicate whether to filter the to-be-filtered data using a plurality of first policies; if the first flag indicates to filter the to-be-filtered data by using the plurality of first policies, determining the plurality of first policies as the plurality of information processing policies; and determining the plurality of data processing modes based on the plurality of information processing policies.

For example, the plurality of first policies may include at least one of a QP adjustment policy, a transform policy, and a fusion policy. For example, the plurality of first policies include the QP adjustment policy and the transform policy, or the plurality of first policies include the QP adjustment policy and the fusion policy. For another example, the plurality of first policies may include the QP adjustment policy, the transform policy, and the fusion policy.

Certainly, in another alternative embodiment, the plurality of first policies may further include a policy of another type or any policy proposed in a future technology for enhancing the performance of the neural network filter. This is not limited in the present disclosure.

From the perspective of coding and decoding, the coder may select, from the plurality of mode combinations, an optimal policy combination and an optimal mode combination in the optimal policy combination based on a filtering cost of a filtered picture corresponding to each of the plurality of mode combinations. Then, the coder may indicate the optimal policy combination using the first flag, to be specific, write the first flag to the code stream, so that the decoder can obtain the plurality of information processing policies by decoding the first flag.

In some embodiments, the first flag is further configured to indicate the first mode combination among the plurality of mode combinations, the plurality of mode combinations include mode combinations obtained by combining data processing modes in different information processing policies among the plurality of information processing policies, and the determining the plurality of data processing modes based on the plurality of information processing policies may be implemented as follows: determining data processing modes included in the first mode combination indicated by the first flag as the plurality of data processing modes.

For example, when the first flag is configured to indicate to filter the to-be-filtered data using the plurality of first policies, the first flag is further configured to indicate the first mode combination among the plurality of mode combinations.

The first flag is described below with reference to Table 5 by using an example in which the plurality of first policies include the QP adjustment policy and the transform policy.

TABLE 5

| Meaning | First flag |
|---|---|
| No QP adjustment policy or transform | 0 |
| policy is to be used. | |
| A QP offset is −5, and rotation | 100 |
| is to be performed leftward by 90°. | |
| A QP offset is +5, and rotation is to | 101 |
| be performed leftward by 90°. | |
| A QP offset is −5, and rotation | 110 |
| is to be performed rightward by 90°. | |
| A QP offset is +5, and rotation is | 111 |
| to be performed rightward by 90°. | |

As shown in Table 5, the coder may indicate, using (different values of) one first flag, that no QP adjustment policy or transform policy is to be used, the QP offset is −5 and rotation is to be performed leftward by 90°, the QP offset is +5 and rotation is to be performed leftward by 90°, the QP offset is −5 and rotation is to be performed rightward by 90°, or the QP offset is +5 and rotation is to be performed rightward by 90°. For example, a value of the first flag being 0 indicates no QP adjustment policy or transform policy is to be used. For another example, a value of the first flag being 100 indicates that the QP offset is −5 and rotation is to be performed leftward by 90°. Certainly, the values of the first flag and the correspondences between the values and the meanings in Table 5 are merely examples, and are not to be construed as a limitation on the present disclosure.

In some embodiments, S412 may include: decoding a code stream to obtain a plurality of second flags, any one of the plurality of second flags being configured to indicate whether to filter the to-be-filtered data using one or more second policies corresponding to the any second flag; if the any second flag indicates to filter the to-be-filtered data using the one or more second policies corresponding to the any second flag, determining the one or more second policies corresponding to the any second flag as information processing policies among the plurality of information processing policies; and determining the plurality of data processing modes based on the plurality of information processing policies.

For example, one of the plurality of second flags is configured to indicate to filter the to-be-filtered data by using the QP adjustment policy and the transform policy, and another one of the plurality of second flags is configured to indicate to filter the to-be-filtered data using the fusion policy.

In some embodiments, the any second flag is further configured to indicate, among target data processing modes, a data processing mode for filtering the to-be-filtered data, the target data processing mode is a data processing mode included in each second policy corresponding to the any second flag, and the determining the plurality of data processing modes based on the plurality of information processing policies may be implemented as follows: determining a data processing mode indicated by the any second flag as a data processing mode among the plurality of data processing modes.

For example, when the any second flag indicates to filter the to-be-filtered data using the one or more second policies corresponding to the any second flag, the any second flag is further configured to indicate, among data processing modes included in all second policies corresponding to the any second flag, a data processing mode for filtering the to-be-filtered data.

For example, the plurality of first policies include the QP adjustment policy and the fusion policy. Two second flags need to be introduced. The two second flags are described below with reference to Table 6 and Table 7.

TABLE 6

| Fusion mode | Second flag | Meaning |
|---|---|---|
| −1 | 00 | No fusion policy is to be used. |
| 0 | 01 | An adaptive weight is to be used. |
| 2 | 10 | A weight to be used is 0.75. |
| 3 | 11 | A weight to be used is 0.5. |

As shown in Table 6, the coder may indicate, using (different values of) one second flag, not to use the fusion policy, use the adaptive weight, use the weight 0.75, or use the weight 0.5. For example, a value of the second flag being 00 indicates that no fusion policy is to be used. For another example, a value of the second flag being 10 indicates to use the weight 0.75, in other words, a scale factor is 0.75. Certainly, the values of the second flag and the correspondences between the values and the meanings in Table 6 are merely examples, and are not to be construed as a limitation on the present disclosure.

When both the QP adjustment policy and the fusion policy are used, based on R_{Blend}=w×R_{NN}+(1−w)×R_{DBF}, the weight being 1 is equivalent to not using the fusion policy. Therefore, when the fusion policy is used, a scale factor of a fusion mode included in the fusion policy may not be 1.

TABLE 7

| QP offset | Second flag | Meaning |
|---|---|---|
| 0 | 0 | No QP offset is to be used. |
| −5/+5 | 1 | A QP offset used for a frame/block |
| | | (TID <4) at a lower time-domain layer is −5, |
| | | and a QP offset used for a frame/block |
| | | (TID ≥4) at an upper time-domain layer |
| | | is +5. |

As shown in Table 7, the decoder may indicate the following two cases by decoding (different values of) the other second flag: Case 1: No QP offset is to be used. Case 2: A QP offset used for a frame/block (TID<4) at a lower time-domain layer is −5, and a QP offset used for a frame/block (TID≥4) at an upper time-domain layer is +5. For example, a value of the second flag being 0 indicates Case 1, and a value of the second flag being 1 indicates Case 2. Certainly, the values of the second flag and the correspondences between the values and the meanings in Table 7 are merely examples, and are not to be construed as a limitation to the present disclosure.

In some embodiments, any one of the plurality of information processing policies is configured for filtering at least one of a frame-level to-be-filtered unit and a block-level to-be-filtered unit.

For example, the any information processing policy is configured for filtering either of the frame-level to-be-filtered unit and the block-level to-be-filtered unit. In this way, a quantity of flags or bits introduced by the any information processing policy can be controlled. This helps control bits occupied by flags related to different information processing policies, to improve decoding efficiency and decoding performance. The any information processing policy being configured for filtering at least one of the frame-level to-be-filtered unit and the block-level to-be-filtered unit may also be understood as that a level of the any information processing policy is at least one of a frame level and a block level.

For example, different information processing policies among the plurality of information processing policies may be configured for filtering to-be-filtered units at different levels. In other words, at least two of the QP adjustment policy, the transform policy, and the fusion policy may be combined at a frame level and/or a block level. Different policies may be configured for filtering to-be-filtered units at different levels.

Exemplary combination manners of information processing policies for filtering to-be-filtered units at different levels are described below using the QP adjustment policy, the transform policy, and the fusion policy as an example.

TABLE 8

| Policy | QP adjustment | Transform | Fusion |
|---|---|---|---|
| combination | policy | policy | policy |
| 1 | Frame-level and | Frame-level and | Frame-level and |
| | block-level | block-level | block-level |
| 2 | Frame-level and | Frame-level | Frame-level and |
| | block-level | | block-level |
| 3 | Frame-level | Frame-level | Frame-level |
| 4 | Block-level | Block-level | Block-level |
| 5 | Frame-level | Frame-level | Block-level |
| 6 | Block-level | Frame-level | Block-level |
| 7 | Frame-level | Frame-level | Frame-level and |
| | | | block-level |
| 8 | Block-level | Frame-level | Frame-level and |
| | | | block-level |

As shown in Table 8, each of the QP adjustment policy, the transform policy, and the fusion policy may be configured for filtering a frame-level to-be-filtered unit and a block-level to-be-filtered unit. Alternatively, one (or two) of the QP adjustment policy, the transform policy, and the fusion policy may be configured for filtering a frame-level to-be-filtered unit and a block-level to-be-filtered unit, and a remaining policy is configured for filtering a frame-level to-be-filtered unit or a block-level to-be-filtered unit. Certainly, the combination manners in Table 8 are merely examples, and are not to be construed as a limitation on the present disclosure. For example, in another alternative embodiment, the transform policy may alternatively not be considered, to be specific, only the QP adjustment policy and the fusion policy are combined.

In some embodiments, the to-be-filtered data further includes at least one of the following: a prediction unit corresponding to the to-be-filtered data, a QP of the to-be-filtered picture to which the to-be-filtered data belongs, and a frame type of the to-be-filtered picture to which the to-be-filtered data belongs.

For example, the prediction unit corresponding to the to-be-filtered data may be a predicted picture configured for determining the to-be-filtered data. For example, when the to-be-filtered data is a to-be-filtered reconstructed picture and the to-be-filtered reconstructed picture is a reconstructed picture determined based on a predicted picture of an original picture and a residual picture of the original picture, the prediction unit corresponding to the to-be-filtered data may be the predicted picture of the original picture.

For example, the QP of the to-be-filtered picture to which the to-be-filtered data belongs may include at least one of the following: a base QP and a slice QP. Certainly, the QP of the to-be-filtered picture to which the to-be-filtered data belongs may alternatively be a QP at another granularity, for example, a block QP. This is not limited in the present disclosure.

For example, the frame type of the to-be-filtered picture to which the to-be-filtered data belongs includes at least one of the following: a P frame, a B frame, and an I frame. The frame type of the to-be-filtered picture to which the to-be-filtered data belongs may also be referred to as a slice type of the to-be-filtered picture to which the to-be-filtered data belongs.

In some embodiments, S413 may include: filtering at least one of the following using the neural network filter based on the plurality of data processing modes, to obtain the filtered data of the to-be-filtered data: a luminance component of the to-be-filtered data, and a chrominance component of the to-be-filtered data.

In this embodiment, filtering at least one of the luminance component (Y) and the chrominance component (UV) of the to-be-filtered data using the plurality of data processing modes is equivalent to enhancing the performance of the neural network filter by combining the plurality of data processing modes determined in the plurality of information processing policies to improve filtering performance of the neural network filter, and further improve filtering effect of the to-be-filtered picture at each component.

FIG. 14 is a schematic flowchart of a filtering method 420 according to an embodiment of the present disclosure.

The filtering method 420 may be performed by a filtering apparatus. For example, the filtering method 420 may be performed by a filtering apparatus in the decoding device 120 or the decoder 122 shown in FIG. 1. For another example, the filtering method 420 may be performed by a filtering apparatus in the video decoder 300 shown in FIG. 4. For ease of description, the filtering method 420 is described below using a filtering apparatus as an example.

As shown in FIG. 14, the filtering method 410 may include at least some or all of the following operations:

S421: Obtain to-be-filtered data.

The to-be-filtered data includes a to-be-filtered unit obtained through decoding. The to-be-filtered unit may be a unit of any type or any size that is obtained through decoding by the decoder and that may be filtered, and may include a picture, a picture block, an audio block, or another unit for signal processing.

S422: When to-be-filtered data in the to-be-filtered data is filtered using a neural network filter, determine a first information processing policy for filtering the to-be-filtered data, the first information processing policy being configured for filtering at least one of a frame-level to-be-filtered unit and a block-level to-be-filtered unit.

S423: Determine a first data processing mode from data processing modes included in the first information processing policy.

S424: Filter the to-be-filtered data using the neural network filter based on the first data processing mode, to obtain filtered data of the to-be-filtered data.

In some embodiments, the first information processing policy includes at least one of the following policies: a QP adjustment policy for adjusting a QP of the to-be-filtered data, a transform policy for performing geometric transform on the to-be-filtered data, and a fusion policy for fusing the filtered data outputted by the neural network filter and filtered data outputted by a filter other than the neural network filter, (i) when the first information processing policy is the QP adjustment policy, the first data processing mode includes a QP adjustment value for adjusting the QP; (ii) when the first information processing policy is the transform policy, the first data processing mode includes a transform mode for performing geometric transform on the to-be-filtered data; or (iii) when the first information processing policy is the fusion policy, the first data processing mode includes a scale factor of the filtered data outputted by the neural network filter.

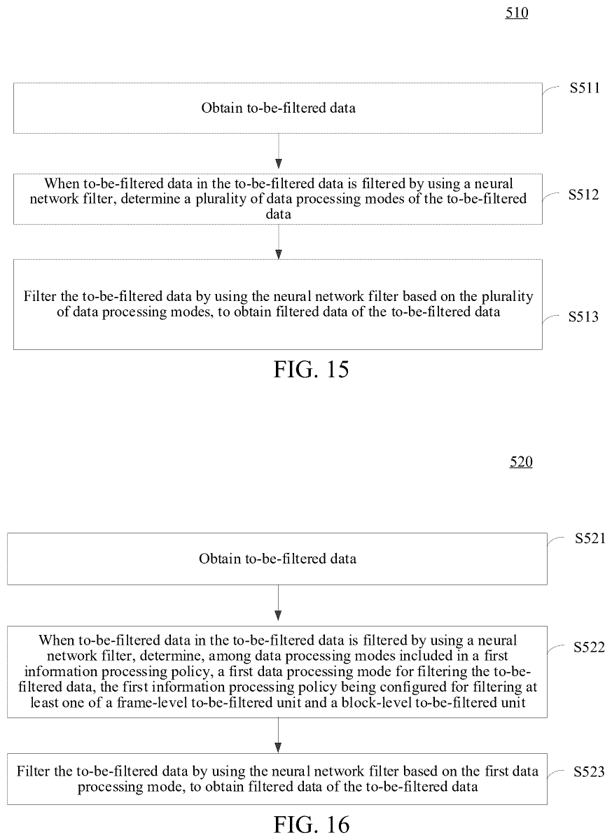

A filtering method 510 and a filtering method 520 according to embodiments of the present disclosure are described below with reference to FIG. 15 and FIG. 16 from the perspective of coding.

The filtering method 510 or the filtering method 520 may be performed by a filtering apparatus in a coder. For example, the filtering method 510 or the filtering method 520 may be performed by a filtering apparatus in the coding device 110 or the coder 112 shown in FIG. 1. For another example, the filtering method 510 or the filtering method 520 may be performed by a filtering apparatus in the video coder 200 shown in FIG. 2.

As shown in FIG. 15, the filtering method 510 may include the following operations:

S511: Obtain to-be-filtered data. The to-be-filtered data includes a to-be-filtered unit obtained through coding. The to-be-filtered unit may be a unit of any type or any size that is obtained through coding by the coder and that may be filtered, and may include a picture, a picture block, an audio block, or another unit for signal processing.

S512: When to-be-filtered data in the to-be-filtered data is filtered using a neural network filter, determine a plurality of data processing modes of the to-be-filtered data.

S513: Filter the to-be-filtered data using the neural network filter based on the plurality of data processing modes, to obtain filtered data of the to-be-filtered data.

In some embodiments, S512 may include: obtaining a plurality of candidate policies; determining a filtering cost of a mode combination of each of a plurality of policy combinations, the plurality of policy combinations including a policy combination obtained by combining the plurality of candidate policies, and the mode combination of each policy combination including a mode combination obtained by combining data processing modes in different candidate policies in the policy combination; determining a mode combination with a smallest cost based on the filtering cost of the mode combination of each policy combination; and determining information processing policies to which data processing modes in the mode combination with the smallest cost belong as the plurality of information processing policies for filtering the to-be-filtered data, and determining the data processing modes in the mode combination with the smallest cost as the plurality of data processing modes.

In some embodiments, determining the plurality of data processing modes for filtering the to-be-filtered data in the method 512 may be: coding a first flag, the first flag being configured to indicate whether to filter the to-be-filtered data using a plurality of first policies.

In some embodiments, the first flag is further configured to indicate a first mode combination among a plurality of mode combinations, and the plurality of mode combinations include mode combinations obtained by combining data processing modes in different information processing policies among the plurality of information processing policies.

In some embodiments, determining the plurality of data processing modes for filtering the to-be-filtered data in the method 512 may be: coding a plurality of second flags, any one of the plurality of second flags being configured to indicate whether to filter the to-be-filtered data using one or more second policies corresponding to the any second flag.

In some embodiments, the any second flag is further configured to indicate, among data processing modes included in all second policies corresponding to the any second flag, a data processing mode for filtering the to-be-filtered data.

In some embodiments, the plurality of information processing policies include at least one of the following policies: a QP adjustment policy for adjusting a QP of the to-be-filtered data, a transform policy for performing geometric transform on the to-be-filtered data, and a fusion policy for fusing the filtered data outputted by the neural network filter and filtered data outputted by a filter other than the neural network filter, (i) when the plurality of information processing policies include the QP adjustment policy, a data processing mode among the plurality of data processing modes that belongs to the QP adjustment policy including a QP adjustment value for adjusting the QP; (ii) when the plurality of information processing policies include the transform policy, a data processing mode among the plurality of data processing modes that belongs to the transform policy including a transform mode for performing geometric transform on the to-be-filtered data; or (iii) when the plurality of information processing policies include the fusion policy, a data processing mode among the plurality of data processing modes that belongs to the fusion policy including a scale factor of the filtered data outputted by the neural network filter.

In some embodiments, the plurality of information processing policies include the QP adjustment policy and the transform policy, or the plurality of information processing policies include the QP adjustment policy and the fusion policy.

In some embodiments, any one of the plurality of information processing policies is configured for filtering at least one of a frame-level to-be-filtered unit and a block-level to-be-filtered unit.

In some embodiments, the to-be-filtered data further includes at least one of the following: a prediction unit corresponding to the to-be-filtered data, a QP of the to-be-filtered picture to which the to-be-filtered data belongs, and a frame type of the to-be-filtered picture to which the to-be-filtered data belongs.

In some embodiments, S513 may include: filtering at least one of the following using the neural network filter based on the plurality of data processing modes, to obtain the filtered data of the to-be-filtered data: a luminance component of the to-be-filtered data, and a chrominance component of the to-be-filtered data.

The filtering method 410 may be understood as a filtering method used in a decoding method, and the filtering method 510 may be understood as a filtering method used in a coding method. Specific principles thereof are similar, and a difference lies in: The filtering method 410 is configured for filtering a to-be-filtered unit obtained through decoding, and the filtering method 510 is configured for filtering a to-be-filtered unit obtained through coding. Therefore, for a specific solution of the filtering method 510, refer to related content of the filtering method 410. For ease of description, details are not described herein again.

As shown in FIG. 16, the filtering method 520 may include the following operations:

S521: Obtain to-be-filtered data. The to-be-filtered data includes a to-be-filtered unit obtained through coding. The to-be-filtered unit may be a unit of any type or any size that is obtained through coding by the coder and that may be filtered, and may include a picture, a picture block, an audio block, or another unit for signal processing.

S522: When to-be-filtered data in the to-be-filtered data is filtered using a neural network filter, determine, among data processing modes included in a first information processing policy, a first data processing mode for filtering the to-be-filtered data, the first information processing policy being configured for filtering at least one of a frame-level to-be-filtered unit and a block-level to-be-filtered unit.

S523: Filter the to-be-filtered data using the neural network filter based on the first data processing mode, to obtain filtered data of the to-be-filtered data.

In some embodiments, the first information processing policy includes at least one of the following policies: a QP adjustment policy for adjusting a QP of the to-be-filtered data, a transform policy for performing geometric transform on the to-be-filtered data, and a fusion policy for fusing the filtered data outputted by the neural network filter and filtered data outputted by a filter other than the neural network filter, (i) when the first information processing policy is the QP adjustment policy, the first data processing mode includes a QP adjustment value for adjusting the QP; (ii) when the first information processing policy is the transform policy, the first data processing mode includes a transform mode for performing geometric transform on the to-be-filtered data; or (iii) when the first information processing policy is the fusion policy, the first data processing mode includes a scale factor of the filtered data outputted by the neural network filter.

The filtering method 420 may be understood as a filtering method used in a decoding method, and the filtering method 520 may be understood as a filtering method used in a coding method. Specific principles thereof are similar, and a difference lies in: The filtering method 420 is configured to filter a to-be-filtered unit obtained through decoding, and the filtering method 520 is configured to filter a to-be-filtered unit obtained through coding. Therefore, for a specific solution of the filtering method 520, reference is made to the related content of the filtering method 420. For ease of description, the details are not reiterated herein.

The exemplary implementations of the present disclosure are described in detail above with reference to the accompanying drawings. However, the present disclosure is not limited to the specific details in the foregoing implementations. A plurality of simple variations may be made to the technical solutions of the present disclosure within a scope of the technical concept of the present disclosure. These simple variations fall within the protection scope of the present disclosure. For example, the specific technical features described in the foregoing specific implementations may be combined in any proper manner in a case without conflict. To avoid unnecessary repetition, various possible combinations are not additionally described in the present disclosure. For another example, different implementations of the present disclosure may alternatively be combined in any manner without departing from the idea of the present disclosure. These combinations shall still be regarded as content disclosed in the present disclosure.

In the method embodiments of the present disclosure, sequence numbers of the foregoing processes do not indicate execution sequences. The execution sequences of the processes are to be determined based on functions and internal logic of the processes, and not to be construed as any limitation on the implementation processes of the embodiments of the present disclosure.

The following describes apparatus embodiments of the present disclosure in detail with reference to the accompanying drawings.

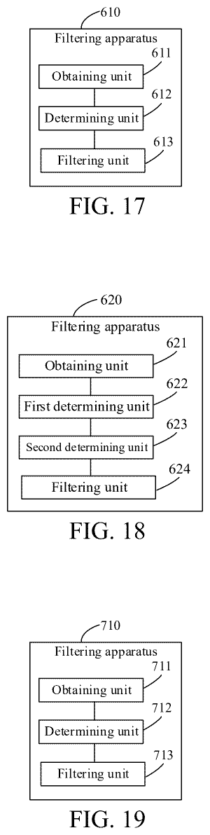

FIG. 17 is a schematic block diagram of a filtering apparatus 600 according to the present disclosure.

As shown in FIG. 17, the filtering apparatus 610 may include: an obtaining unit 611, configured to obtain to-be-filtered data; a determining unit 612, configured to: when to-be-filtered data in the to-be-filtered data is filtered by to using a neural network filter, determine a plurality of data processing modes of the to-be-filtered data; and a filtering unit 613, configured to filter the to-be-filtered data using the neural network filter based on the plurality of data processing modes, to obtain filtered data of the to-be-filtered data.

In some embodiments, when the plurality of data processing modes form a first mode combination, the first mode combination is a mode combination with a smallest filtering cost among a plurality of mode combinations.

In some embodiments, the determining unit 612 is further configured to: determine a plurality of information processing policies for filtering the to-be-filtered data; and the determining unit 612 is configured to: decode a code stream to obtain a first flag, the first flag being configured to indicate whether to filter the to-be-filtered data using a plurality of first policies; and if the first flag indicates to filter the to-be-filtered data using the plurality of first policies, determine the plurality of first policies as the plurality of information processing policies; and determine the plurality of data processing modes based on the plurality of information processing policies.

In some embodiments, the first flag is further configured to indicate a first mode combination among a plurality of mode combinations, and the plurality of mode combinations include mode combinations obtained by combining data processing modes in different information processing policies among the plurality of information processing policies.

The determining unit 612 is configured to determine data processing modes included in the first mode combination indicated by the first flag as the plurality of data processing modes.

In some embodiments, the determining unit 612 is configured to: determine a plurality of information processing policies for filtering the to-be-filtered data; and the determining unit 612 is configured to: decode a code stream to obtain a plurality of second flags, any one of the plurality of second flags being configured to indicate whether to filter the to-be-filtered data using one or more second policies corresponding to the any second flag; and if the any second flag indicates to filter the to-be-filtered data using the one or more second policies corresponding to the any second flag, determine the one or more second policies corresponding to the any second flag as information processing policies among the plurality of information processing policies; and determine the plurality of data processing modes based on the plurality of information processing policies.

In some embodiments, the any second flag is further configured to indicate, among data processing modes included in all second policies corresponding to the any second flag, a data processing mode for filtering the to-be-filtered data.

The determining unit 612 is configured to determine a data processing mode indicated by the any second flag as a data processing mode among the plurality of data processing modes.

In some embodiments, the plurality of information processing policies include at least one of the following policies: a QP adjustment policy for adjusting a QP of the to-be-filtered data, a transform policy for performing geometric transform on the to-be-filtered data, and a fusion policy for fusing the filtered data outputted by the neural network filter and filtered data outputted by a filter other than the neural network filter, (i) when the plurality of information processing policies include the QP adjustment policy, a data processing mode among the plurality of data processing modes that belongs to the QP adjustment policy including a QP adjustment value for adjusting the QP; (ii) when the plurality of information processing policies include the transform policy, a data processing mode among the plurality of data processing modes that belongs to the transform policy including a transform mode for performing geometric transform on the to-be-filtered data; or (iii) when the plurality of information processing policies include the fusion policy, a data processing mode among the plurality of data processing modes that belongs to the fusion policy including a scale factor of the filtered data outputted by the neural network filter.

In some embodiments, the plurality of information processing policies include the QP adjustment policy and the transform policy, or the plurality of information processing policies include the QP adjustment policy and the fusion policy.

In some embodiments, any one of the plurality of information processing policies is configured for filtering at least one of a frame-level to-be-filtered unit and a block-level to-be-filtered unit.

In some embodiments, the to-be-filtered data further includes at least one of the following: a prediction unit corresponding to the to-be-filtered data, a QP of the to-be-filtered picture to which the to-be-filtered data belongs, and a frame type of the to-be-filtered picture to which the to-be-filtered data belongs.

In some embodiments, the filtering unit 613 is configured to filter at least one of the following using the neural network filter based on the plurality of data processing modes, to obtain the filtered data of the to-be-filtered data: a luminance component of the to-be-filtered data, and a chrominance component of the to-be-filtered data.

The apparatus embodiments and the method embodiments of the filtering method may correspond to each other. For similar descriptions, refer to the method embodiments. The filtering apparatus 610 may correspond to a corresponding entity for performing the filtering method 410 in the embodiments of the present disclosure, and the foregoing and other operations and/or functions of the units in the filtering apparatus 610 are respectively intended to implement corresponding processes in the filtering method 410. To avoid repetition, details are not described herein again.

FIG. 18 is a schematic block diagram of a filtering apparatus 620 according to the present disclosure.

As shown in FIG. 18, the filtering apparatus 620 may include: an obtaining unit 621, configured to obtain to-be-filtered data, the to-be-filtered data including to-be-filtered data obtained through decoding; a first determining unit 622, configured to: when to-be-filtered data in the to-be-filtered data is filtered by to using a neural network filter, determine a first information processing policy for filtering the to-be-filtered data, the first information processing policy being configured for filtering at least one of a frame-level to-be-filtered unit and a block-level to-be-filtered unit; a second determining unit 623, configured to determine a first data processing mode from data processing modes included in the first information processing policy; and a filtering unit 624, configured to filter the to-be-filtered data using the neural network filter based on the first data processing mode, to obtain filtered data of the to-be-filtered data.

In some embodiments, the first information processing policy includes at least one of the following policies: a QP adjustment policy for adjusting a QP of the to-be-filtered data, a transform policy for performing geometric transform on the to-be-filtered data, and a fusion policy for fusing the filtered data outputted by the neural network filter and filtered data outputted by a filter other than the neural network filter, (i) when the first information processing policy is the QP adjustment policy, the first data processing mode includes a QP adjustment value for adjusting the QP; (ii) when the first information processing policy is the transform policy, the first data processing mode includes a transform mode for performing geometric transform on the to-be-filtered data; or (iii) when the first information processing policy is the fusion policy, the first data processing mode includes a scale factor of the filtered data outputted by the neural network filter.

The apparatus embodiments and the method embodiments of the filtering method may correspond to each other. For similar descriptions, reference is made to the method embodiments. The filtering apparatus 620 may correspond to a corresponding entity for performing the filtering method 420 in the embodiments of the present disclosure, and the foregoing and other operations and/or functions of the units in the filtering apparatus 620 are respectively intended to implement corresponding processes in the filtering method 420. To avoid repetition, the details are not reiterated herein.

FIG. 19 is a schematic block diagram of a filtering apparatus 710 according to the present disclosure.

As shown in FIG. 19, the filtering apparatus 710 may include: an obtaining unit 711, configured to obtain to-be-filtered data; a determining unit 712, configured to: when to-be-filtered data in the to-be-filtered data is filtered by to using a neural network filter, determine a plurality of data processing modes of the to-be-filtered data; and a filtering unit 713, configured to filter the to-be-filtered data using the neural network filter based on the plurality of data processing modes, to obtain filtered data of the to-be-filtered data.

In some embodiments, the determining unit 712 is configured to: obtain a plurality of candidate policies; determine a filtering cost of a mode combination of each of a plurality of policy combinations, the plurality of policy combinations including a policy combination obtained by combining the plurality of candidate policies, and the mode combination of each policy combination including a mode combination obtained by combining data processing modes in different candidate policies in the policy combination; determine a mode combination with a smallest cost based on the filtering cost of the mode combination of each policy combination; and determine information processing policies to which data processing modes in the mode combination with the smallest cost belong as the plurality of information processing policies for filtering the to-be-filtered data, and determine the data processing modes in the mode combination with the smallest cost as the plurality of data processing modes.

In some embodiments, the determining unit 712 is configured to: code a first flag, the first flag being configured to indicate whether to filter the to-be-filtered data using a plurality of first policies; if the first flag indicates to filter the to-be-filtered data using the plurality of first policies, determine the plurality of first policies as a plurality of information processing policies; and determine the plurality of data processing modes based on the plurality of information processing policies.

In some embodiments, the first flag is further configured to indicate a first mode combination among a plurality of mode combinations, and the plurality of mode combinations include mode combinations obtained by combining data processing modes in different information processing policies among the plurality of information processing policies.

In some embodiments, the determining unit 712 is configured to: code a plurality of second flags, any one of the plurality of second flags being configured to indicate whether to filter the to-be-filtered data using one or more second policies corresponding to the any second flag; if the any second flag indicates to filter the to-be-filtered data using the one or more second policies corresponding to the any second flag, determine the one or more second policies corresponding to the any second flag as information processing policies among the plurality of information processing policies; and determine the plurality of data processing modes based on the plurality of information processing policies.

In some embodiments, the any second flag is further configured to indicate, among target data processing modes, a data processing mode for filtering the to-be-filtered data, and the target data processing mode is a data processing mode included in each second policy corresponding to the any second flag.

The determining unit 712 is configured to determine a data processing mode indicated by the any second flag as a data processing mode among the plurality of data processing modes.

In some embodiments, the plurality of information processing policies include at least one of the following policies: a QP adjustment policy for adjusting a QP of the to-be-filtered data, a transform policy for performing geometric transform on the to-be-filtered data, and a fusion policy for fusing the filtered data outputted by the neural network filter and filtered data outputted by a filter other than the neural network filter, (i) when the plurality of information processing policies include the QP adjustment policy, a data processing mode among the plurality of data processing modes that belongs to the QP adjustment policy including a QP adjustment value for adjusting the QP; (ii) when the plurality of information processing policies include the transform policy, a data processing mode among the plurality of data processing modes that belongs to the transform policy including a transform mode for performing geometric transform on the to-be-filtered data; or (iii) when the plurality of information processing policies include the fusion policy, a data processing mode among the plurality of data processing modes that belongs to the fusion policy including a scale factor of the filtered data outputted by the neural network filter.

In some embodiments, the plurality of information processing policies include the QP adjustment policy and the transform policy, or the plurality of information processing policies include the QP adjustment policy and the fusion policy.

In some embodiments, any one of the plurality of information processing policies is configured for filtering at least one of a frame-level to-be-filtered unit and a block-level to-be-filtered unit.

In some embodiments, the to-be-filtered data further includes at least one of the following: a prediction unit corresponding to the to-be-filtered data, a QP of the to-be-filtered picture to which the to-be-filtered data belongs, and a frame type of the to-be-filtered picture to which the to-be-filtered data belongs.

In some embodiments, the filtering unit 713 is configured to: filter at least one of the following using the neural network filter based on the plurality of data processing modes, to obtain the filtered data of the to-be-filtered data: a luminance component of the to-be-filtered data, and a chrominance component of the to-be-filtered data.

The apparatus embodiments of the coder and the method embodiments of the filtering method may correspond to each other. For similar descriptions, reference is made to the method embodiments. The filtering apparatus 710 may correspond to a corresponding entity for performing the filtering method 510 in the embodiments of the present disclosure, and the foregoing and other operations and/or functions of the units in the filtering apparatus 710 are respectively intended to implement corresponding processes in the methods such as the filtering method 510. To avoid repetition, the details are not reiterated herein.

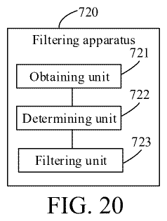

FIG. 20 is a schematic block diagram of a filtering apparatus 720 according to the present disclosure.

As shown in FIG. 20, the filtering apparatus 720 may include: an obtaining unit 721, configured to obtain to-be-filtered data; a determining unit 722, configured to: when to-be-filtered data in the to-be-filtered data is filtered using a neural network filter, determine, among data processing modes included in a first information processing policy, a first data processing mode for filtering the to-be-filtered data, the first information processing policy being configured to filter a to-be-filtered unit of at least one of the following levels: a frame level and a block level; and a filtering unit 723, configured to filter the to-be-filtered data using the neural network filter based on the first data processing mode to obtain filtered data of the to-be-filtered data.

In some embodiments, the first information processing policy includes at least one of the following policies: a QP adjustment policy for adjusting a QP of the to-be-filtered data, a transform policy for performing geometric transform on the to-be-filtered data, and a fusion policy for fusing the filtered data outputted by the neural network filter and filtered data outputted by a filter other than the neural network filter, (i) when the first information processing policy is the QP adjustment policy, the first data processing mode includes a QP adjustment value for adjusting the QP; (ii) when the first information processing policy is the transform policy, the first data processing mode includes a transform mode for performing geometric transform on the to-be-filtered data; or (iii) when the first information processing policy is the fusion policy, the first data processing mode includes a scale factor of the filtered data outputted by the neural network filter.

The apparatus embodiments of the coder and the method embodiments of the filtering method may correspond to each other. For similar descriptions, reference is made to the method embodiments. The filtering apparatus 720 may correspond to a corresponding entity for performing the filtering method 520 in the embodiments of the present disclosure, and the foregoing and other operations and/or functions of the units in the filtering apparatus 720 are respectively intended to implement corresponding processes in the methods such as the filtering method 520. To avoid repetition, the details are not reiterated herein.

The units in the filtering apparatus (for example, the filtering apparatus 610, the filtering apparatus 620, the filtering apparatus 710, or the filtering apparatus 720) in the embodiments of the present disclosure are divided based on logical functions. During actual application, a function of one unit may be implemented by a plurality of units, or functions of a plurality of units may be implemented by one unit, or these functions may even be cooperatively implemented by one or more other units. For example, some or all of units in the filtering apparatus are combined into one or more other units. For another example, one or more units in the filtering apparatus may alternatively be split into a plurality of units with smaller functions. In this way, the same operations can be implemented, without affecting achievement of the technical effects of the embodiments of the present disclosure. For another example, the filtering apparatus may alternatively include another unit. During actual application, these functions may alternatively be cooperatively implemented by another unit and may be cooperatively implemented by a plurality of units.

According to another embodiment of the present disclosure, a computer program (including program code) capable of performing the operations included in a corresponding method may be run on a general-purpose computing device of a general-purpose computer that includes a processing element and a storage element such as a central processing unit (CPU), a random access memory (RAM), and a read-only memory (ROM), to construct the filtering apparatus in the embodiments of the present disclosure, and implement the filtering method in the embodiments of the present disclosure. The computer program may be stored in, for example, a computer-readable storage medium, and is installed on an electronic device through the computer-readable storage medium. When the computer program is run on the electronic device, a corresponding method in the embodiments of the present disclosure is performed.

In other words, the foregoing units may be implemented in a form of hardware, or may be implemented by instructions in a form of software, or may be implemented by a combination of hardware and software.

The operations of the method embodiments in the embodiments of the present disclosure may be performed by a hardware integrated logic circuit in a processor and/or instructions in a form of software. The operations of the methods disclosed in the embodiments of the present disclosure may be directly embodied as being performed by a hardware decoding processor, or may be performed by a combination of hardware and software in a decoding processor. In some embodiments, the software may be located in a mature storage medium in the art, for example, a RAM, a flash memory, a ROM, a programmable ROM (PROM), an electrically erasable programmable memory, or a register. The processor reads information in the storage medium and completes the operations in the foregoing method embodiments in combination with hardware thereof.

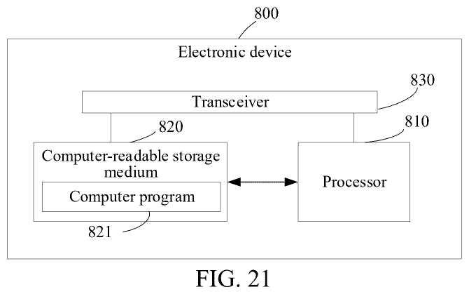

FIG. 21 is a schematic structural diagram of an electronic device 800 according to the present disclosure.

As shown in FIG. 21, the electronic device 800 includes at least a processor 810 and a computer-readable storage medium 820. The processor 810 and the computer-readable storage medium 820 may be connected through a bus or in another manner. The computer-readable storage medium 820 may be configured to store a computer program 821. The computer program 821 includes computer instructions. The processor 810 is configured to execute the computer instructions stored in the computer-readable storage medium 820. The processor 810 is a computing core and a control core of the electronic device 800, is suitable for implementing one or more computer instructions, and is suitable for loading and executing one or more computer instructions to implement a corresponding method process or a corresponding function.

For example, the processor 810 may also be referred to as a CPU. The processor 810 may include but is not limited to a general-purpose processor, a digital signal processor (DSP), an application-specific integrated circuit (ASIC), a field programmable gate array (FPGA), another programmable logic device, a transistor logic device, a discrete hardware component, and the like.

For example, the computer-readable storage medium 820 may be a high-speed RAM, or may be a non-volatile memory, for example, at least one magnetic disk memory, or in some embodiments, may be at least one computer-readable storage medium located away from the processor 810. The computer-readable storage medium 820 includes but is not limited to a volatile memory and/or a non-volatile memory. The non-volatile memory may be a ROM, a PROM, an erasable PROM (EPROM), an electrically EPROM (EEPROM), or a flash memory. The volatile memory may be a RAM, serving as an external cache. By way of example but not limitative description, RAMs in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

For example, the electronic device 800 may be the filtering apparatus in the embodiments of the present disclosure, the computer-readable storage medium 820 stores computer instructions, and the processor 810 loads and executes the computer instructions stored in the computer-readable storage medium 820 to implement corresponding operations in the filtering method provided in the present disclosure. In other words, the computer instructions in the computer-readable storage medium 820 may be loaded by the processor 810 to perform corresponding operations. To avoid repetition, details are not described herein again.

According to another aspect of the present disclosure, the present disclosure further provides a coding method or a coder. In the coding method, coding may be performed using the filtering method provided in the present disclosure. The coder may perform coding using the filtering method provided in the present disclosure.

According to another aspect of the present disclosure, the present disclosure further provides a decoding method or a decoder. In the decoding method, decoding may be performed using the filtering method provided in the present disclosure. The decoder may perform decoding using the filtering method provided in the present disclosure.

According to another aspect of the present disclosure, the present disclosure further provides a coding and decoding system, including the coder and the decoder in the foregoing descriptions. The coder may perform coding using the filtering method provided in the present disclosure, and the decoder may perform decoding using the filtering method provided in the present disclosure.

According to another aspect of the present disclosure, the present disclosure further provides a computer-readable storage medium (memory). The computer-readable storage medium stores computer instructions. When the computer instructions are read and executed by a processor of a computer device, the computer device is enabled to perform the foregoing filtering method.

The computer-readable storage medium is a memory device in a decoder or a coder, and is configured to store a program and data. The computer-readable storage medium herein may include both an internal storage medium in an electronic device and certainly an extended storage medium supported by the electronic device. The computer-readable storage medium may be configured to provide storage space, and the storage space may store an operating system of the electronic device. In addition, the storage space further stores one or more computer instructions suitable for being loaded and executed by a processor, for example, stores one or more computer instructions for performing the foregoing filtering method. These computer instructions may be one or more computer programs (including program code).

According to another aspect, the present disclosure further provides a computer program product or a computer program. The computer program product or the computer program includes computer instructions. The computer instructions are stored in a computer-readable storage medium. A processor of a computer device reads the computer instructions from the computer-readable storage medium, and the processor executes the computer instructions, to enable the computer to perform the filtering method provided in the foregoing embodiments.

The computer device in the present disclosure may be any device or apparatus capable of data processing, for example, including but not limited to a general-purpose computer, a dedicated computer, a computer network, or another programmable apparatus. In addition, the computer instructions in the present disclosure may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) mode.

According to another aspect of the present disclosure, the present disclosure further provides a code stream. The code stream may be a code stream decoded using the filtering method provided in the present disclosure or a code stream generated using the filtering method provided in the present disclosure.

A person of ordinary skill in the art may be aware that the exemplary units and process operations described with reference to the embodiments disclosed in this specification can be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application. However, the implementation still falls within the scope of the present disclosure.

The foregoing content is merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A filtering method, the method comprising:
obtaining data to be filtered;
based on the data being filtered using a neural network filter, determining a plurality of data processing modes of the data; and
filtering, based on the plurality of data processing modes, the data using the neural network filter to obtain corresponding filtered data.

2. The filtering method according to claim 1, wherein the plurality of data processing modes comprise a first mode combination, the first mode combination being a mode combination with a smallest filtering cost among a plurality of mode combinations.

3. The filtering method according to claim 1, wherein the determining the plurality of data processing modes of the data comprises:
decoding a code stream to obtain a first flag, the first flag being configured to indicate whether to filter the data using a plurality of first policies;
if the first flag indicates to filter the data using the plurality of first policies, determining the plurality of first policies as being a plurality of information processing policies; and
determining the plurality of data processing modes based on the plurality of information processing policies.

4. The filtering method according to claim 3, wherein
(i) the first flag is further configured to indicate the first mode combination among the plurality of mode combinations, the plurality of mode combinations comprising mode combinations obtained by combining data processing modes in different information processing policies among the plurality of information processing policies, and
(ii) the determining the plurality of data processing modes based on the plurality of information processing policies comprises:
determining data processing modes in the first mode combination, the determining data processing modes being indicated by the first flag as the plurality of data processing modes.

5. The filtering method according to claim 1, wherein the determining the plurality of data processing modes of the data comprises:
decoding a code stream to obtain a plurality of second flags, any one of the plurality of second flags being configured to indicates whether to filter the data using one or more second policies;
if the any one of the plurality of second flag indicates to filter the data using the one or more corresponding second policies, determining the one or more second policies corresponding to the any one of the plurality of second flag as being information processing policies among the plurality of information processing policies; and
determining the plurality of data processing modes based on the plurality of information processing policies.

6. The filtering method according to claim 5, wherein
(i) the any one of the plurality of second flag is further configured to indicate, among target data processing modes, a data processing mode for filtering the data, the target data processing mode being a data processing mode in each one of the one or more second policies corresponding to the any one of the plurality of second flag, and
(ii) the determining the plurality of data processing modes based on the plurality of information processing policies comprises:
determining a data processing mode indicated by the any one of the plurality of second flag as a data processing mode among the plurality of data processing modes.

7. The filtering method according to claim 3, wherein the plurality of information processing policies comprise at least one of the following policies:
a quantization parameter adjustment policy for adjusting a quantization parameter of the data, a transform policy for performing geometric transform on the data, and a fusion policy for fusing the filtered data outputted by the neural network filter and filtered data outputted by a filter other than the neural network filter,
when the plurality of information processing policies comprise the quantization parameter adjustment policy, a data processing mode among the plurality of data processing modes that belongs to the quantization parameter adjustment policy comprising a quantization parameter adjustment value for adjusting the quantization parameter;
when the plurality of information processing policies comprise the transform policy, a data processing mode among the plurality of data processing modes that belongs to the transform policy comprising a transform mode for performing geometric transform on the data; and
when the plurality of information processing policies comprise the fusion policy, a data processing mode among the plurality of data processing modes that belongs to the fusion policy comprising a scale factor of the filtered data outputted by the neural network filter.

8. The filtering method according to claim 7, wherein the plurality of information processing policies comprise the quantization parameter adjustment policy and the transform policy, or the plurality of information processing policies comprise the quantization parameter adjustment policy and the fusion policy.

9. The filtering method according to claim 3, wherein any one of the plurality of information processing policies is configured to filter at least one of a frame-level to-be-filtered unit and a block-level to-be-filtered unit.

10. The filtering method according to claim 1, wherein the data further comprises at least one of the following:
a prediction unit corresponding to the data, a quantization parameter of a to-be-filtered picture to which the data belongs, and a frame type of the to-be-filtered picture to which the to-be-filtered data belongs.

11. The filtering method according to claim 1, wherein the filtering the data using the neural network filter to obtain corresponding filtered data comprises:
filtering at least one of the following using the neural network filter to obtain the filtered data of the to-be-filtered data:
a luminance component of the data, and a chrominance component of the data.

12. The filtering method according to claim 1, wherein when the data comprises a to-be-filtered data unit obtained through coding, the plurality of data processing modes of the data comprise:
obtaining a plurality of candidate policies;
determining a filtering cost of a mode combination of each of a plurality of policy combinations, the plurality of policy combinations comprising a policy combination obtained by combining the plurality of candidate policies, and the mode combination of each policy combination comprising a mode combination obtained by combining data processing modes in different candidate policies in the policy combination;
determining a mode combination with a smallest cost based on the filtering cost of the mode combination of each policy combination; and
determining information processing policies to which data processing modes in the mode combination with the smallest cost belong as the plurality of information processing policies for filtering the data, and determining the data processing modes in the mode combination with the smallest cost as the plurality of data processing modes.

13. A filtering apparatus, comprising:
at least one memory configured to store program code; and
at least one processor configured to read the program code and operate as instructed by the program code, the program code comprising:
an obtaining code configured to cause the at least one of the at least one processor to obtain data;
a determining code configured to cause the at least one of the at least one processor to, based on the data is filtered using a neural network filter, determine a plurality of data processing modes of the data; and
a filtering code configured to cause the at least one of the at least one processor to filter, based on the plurality of data processing modes, the data using the neural network filter to obtain corresponding filtered data.

14. The filtering apparatus according to claim 13, wherein the plurality of data processing modes comprise a first mode combination, the first mode combination being a mode combination with a smallest filtering cost among a plurality of mode combinations.

15. The filtering apparatus according to claim 13, wherein the determining code is further configured to cause at least one of the at least one processor to:
decode a code stream to obtain a first flag, the first flag being configured to indicate whether to filter the data using a plurality of first policies;
if the first flag indicates to filter the data using the plurality of first policies, determine the plurality of first policies as being a plurality of information processing policies; and
determine the plurality of data processing modes based on the plurality of information processing policies.

16. The filtering apparatus according to claim 15, wherein
(i) the first flag is further configured to indicate the first mode combination among the plurality of mode combinations, the plurality of mode combinations comprising mode combinations obtained by combining data processing modes in different information processing policies among the plurality of information processing policies, and
(ii) the determining the plurality of data processing modes based on the plurality of information processing policies comprises:
determining data processing modes in the first mode combination, the determining data processing modes being indicated by the first flag as the plurality of data processing modes.

17. The filtering apparatus according to claim 13, wherein the determining code is further configured to cause at least one of the at least one processor to:
decode a code stream to obtain a plurality of second flags, any one of the plurality of second flags being configured to indicates whether to filter the data using one or more second policies;
if the any one of the plurality of second flag indicates to filter the data using the one or more corresponding second policies, determine the one or more second policies corresponding to the any one of the plurality of second flag as being information processing policies among the plurality of information processing policies; and
determine the plurality of data processing modes based on the plurality of information processing policies.

18. The filtering apparatus according to claim 17, wherein
(i) the any one of the plurality of second flag is further configured to indicate, among target data processing modes, a data processing mode for filtering the data, the target data processing mode being a data processing mode in each one of the one or more second policies corresponding to the any one of the plurality of second flag, and
(ii) the determining the plurality of data processing modes based on the plurality of information processing policies comprises:
determining a data processing mode indicated by the any one of the plurality of second flag as a data processing mode among the plurality of data processing modes.

19. The filtering apparatus according to claim 15, wherein any one of the plurality of information processing policies is configured to filter at least one of a frame-level to-be-filtered unit and a block-level to-be-filtered unit.

20. A non-transitory computer-readable storage medium, storing computer code which, when executed by at least one processor, causes the at least one processor to at least:
obtain data to be filtered;
based on the data being filtered using a neural network filter, determine a plurality of data processing modes of the data; and
filter, based on the plurality of data processing modes, the data using the neural network filter to obtain corresponding filtered data.
